(19) United States
(12) Patent Application Publication
(10) Pub. No.: US 2024/0320457 A1
(43) Pub. Date: Sep. 26, 2024

(54) INK JET SYSTEM

(71) Applicant: SEIKO EPSON CORPORATION, Tokyo (JP)

(72) Inventors: Toshiro MURAYAMA, FUJIMI-MACHI (JP); Tomonaga HASEGAWA, MATSUMOTO-SHI (JP); Akira MIYAGISHI, SHIOJIRI-SHI (JP); Nobuaki ITO, SUWA-SHI (JP)

(21) Appl. No.: 18/611,372

(22) Filed: Mar. 20, 2024

(30) Foreign Application Priority Data
Mar. 22, 2023 (JP) 2023-045050

(51) Int. Cl. G06K 15/10; G06K 15/00; G06Q 30/0207

(52) U.S. Cl. CPC G06K 15/102; G06K 15/002; G06K 15/4095; G06Q 30/0224; G06Q 30/0236

(57) ABSTRACT

An ink jet system includes a recording device on which a head unit that ejects ink is mounted and that executes a recording operation on a recording medium, a processing device coupled to the recording device and performing a data process for causing the recording device to execute the recording operation, and a server configured to be coupled to either the recording device or the processing device, wherein the server authenticates a user who causes the recording device to execute the recording operation, acquires recording operation information about the recording operation from the recording device, the processing device, or a terminal device used by the user, determines reward information indicating one or a plurality of rewards based on trigger information including part of or all of the recording operation information, and grants the user one or a plurality of rewards indicated by the reward information.

The present application is based on, and claims priority from JP Application Serial Number 2023-045050, filed Mar. 22, 2023, the disclosure of which is hereby incorporated by reference herein in its entirety.

### BACKGROUND

### 1. Technical Field

The present disclosure relates to an ink jet system.

### 2. Related Art

In the related art, there has been provided a recording device such as an ink jet printer on which a head unit that ejects ink is mounted and that executes a recording operation on a recording medium such as printing paper. For example, JP-A-2021-84388 discloses a recording device that applies a waveform of a drive signal to a drive element provided in a head unit in order to eject ink.

With the above-mentioned technology in the related art, it is conceivable that a server is coupled to either a recording device or a processing device that executes a data process, and the server collects recording operation information about the recording operation in order to improve the results of the recording operation. However, in the above-mentioned technology in the related art, the user who uses one or both of the recording device and the processing device does not need to transmit recording operation information to the server, so that it is difficult for the server to collect recording operation information.

### SUMMARY

According to an aspect of the present disclosure, an ink jet system includes a recording device on which a head unit that ejects ink is mounted and that executes a recording operation on a recording medium, a processing device coupled to the recording device and performing a data process for causing the recording device to execute the recording operation, and a server configured to be coupled to either the recording device or the processing device, wherein the server authenticates a user who causes the recording device to execute the recording operation, acquires recording operation information about the recording operation from the recording device, the processing device, or a terminal device used by the user, determines reward information indicating one or a plurality of rewards based on trigger information including part of or all of the recording operation information, and grants the user one or a plurality of rewards indicated by the reward information.

### BRIEF DESCRIPTION OF THE DRAWINGS

FIG. 1 is a schematic diagram showing a configuration example of an ink jet system according to the first embodiment.

FIG. 2 is a diagram showing an example of the configuration of a server.

FIG. 3 is a diagram showing the configuration of a mobile terminal.

FIG. 4 is a diagram showing the configuration of a processing device.

FIG. 5 is a schematic diagram illustrating an example of the configuration of an ink jet printer.

FIG. 6 is a block diagram showing a configuration example of the ink jet printer.

FIG. 7 is a cross-sectional view showing a configuration example of a head chip.

FIG. 8 is a diagram showing the functions of the ink jet system.

FIG. 9 is a flowchart showing a series of operations of the ink jet system.

FIG. 10 is a flowchart showing a series of operations of the ink jet system.

FIG. 11 is a flowchart showing a series of operations of the ink jet system.

FIG. 12 is a diagram showing an example of an account authentication screen.

FIG. 13 is a diagram showing an example of a condition information input screen.

FIG. 14 is a diagram showing an example of a confirmation dialog.

FIG. 15 is a diagram for describing an example of generating control information.

FIG. 16 is a diagram showing an example of a recording operation execution screen.

FIG. 17 is a diagram showing an example of a characteristic information acquisition screen.

FIG. 18 is a diagram showing an example of an evaluation information acquisition screen.

FIG. 19 is a diagram showing an example of the details of a recording operation information database.

FIG. 20 is a diagram for describing an example of determining reward information.

FIG. 21 is a diagram for describing an example of control information according to the first modification.

FIG. 22 is a diagram showing an example of a recording operation execution screen according to the first modification.

FIG. 23 is a diagram showing a flowchart showing a series of operations of the ink jet system according to the second modification.

FIG. 24 is a diagram showing an example of a reward selection screen.

FIG. 25 is a diagram for describing recording operation information and trigger information in the fifth modification.

FIG. 26 is a diagram for describing a determination unit according to the sixth modification.

### DESCRIPTION OF EMBODIMENTS

Hereinafter, embodiments for carrying out the present disclosure will be described with reference to the drawings. However, in each figure, the size and scale of each part are appropriately changed from the actual ones. In addition, since the embodiments described below are preferable specific examples of the present disclosure, there are various technically preferred limitations. However, the scope of the present disclosure is not limited to these embodiments unless otherwise specified in the following description.

### 1. First Embodiment

### 1-1. Overview of Ink Jet System 10

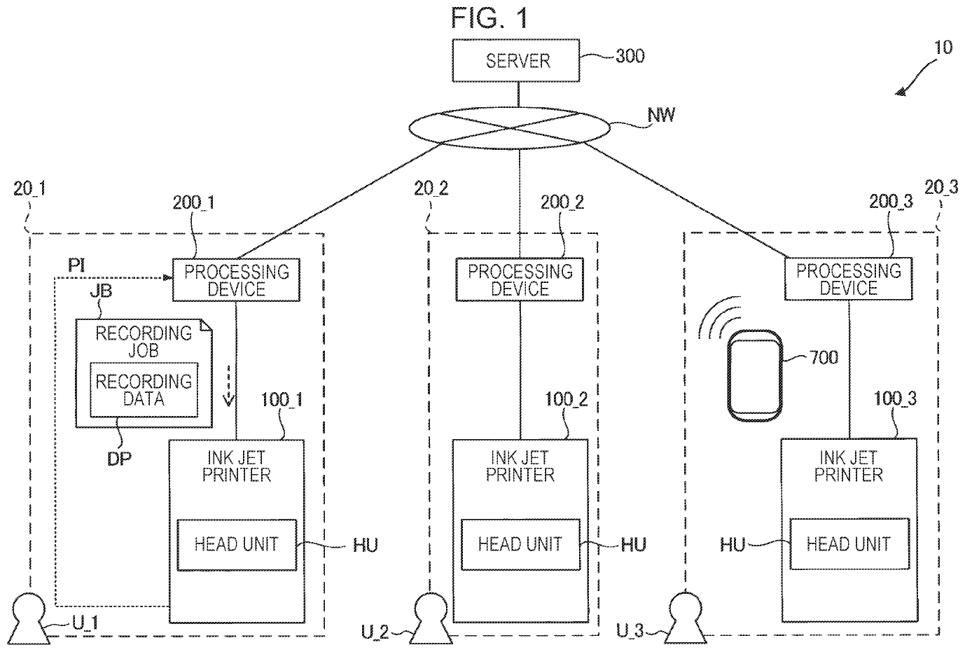

FIG. 1 is a schematic diagram showing the configuration example of an ink jet system 10 according to the first embodiment. The ink jet system 10 is a system that performs recording on a recording medium PP, which will be described later, by an ink jet method. In the example shown in FIG. 1, the ink jet system 10 includes ink jet printers 100_1 to 100_3, processing devices 200_1 to 200_3, a server 300, and a mobile terminal 700.

Here, the ink jet printers 100_1 to 100_3 are provided by the manufacturer of the ink jet printers 100_1 to 100_3. In the following description, the ink jet printers 100_1 to 100_3 may be collectively referred to as an ink jet printer 100 without distinction. The ink jet printer 100 is a liquid ejection apparatus that ejects ink, which is an example of a liquid. The manufacturer of the ink jet printer 100 is a company that manufactures the ink jet printer 100. The manufacturer of the ink jet printer 100 may be referred to as a “printer manufacturer”. Each of the ink jet printers 100_1 to 100_3 may be provided by the same printer manufacturer, or may be provided by different printer manufacturers. However, a head unit HU incorporated in the ink jet printers 100_1 to 100_3 is provided by the manufacturer of the head unit HU. The head unit HU manufacturer is a company that manufactures the head unit HU. Hereinafter, the manufacturer of the head unit HU may be referred to as a “head manufacturer”. The printer manufacturer manufactures the ink jet printer 100 by receiving the head unit HU from the head manufacturer and incorporating the provided head unit HU into the ink jet printer 100. The ink jet printer 100 is an example of a “recording device”.

FIG. 1 shows a user U_1 using the ink jet printer 100_1, a user U_2 using the ink jet printer 100_2, and a user U_3 using the ink jet printer 100_3. In the following description, the users U_1 to U_3 may be collectively referred to as a user U without distinction. In terms of the user U, for example, when a worker belonging to a printer manufacturer uses the ink jet printer 100, the worker is the user U. Further, for example, when a third party who has received the ink jet printer 100 from the printer manufacturer uses the ink jet printer 100, the third party is the user U. In the following description, a third party who receives the ink jet printer 100 from the printer manufacturer may be referred to as an “end user”. For each integer i from 1 to 3, a user U_i uses a processing device 200_i in addition to an ink jet printer 100_i.

The ink jet printer 100_1 is communicably connected to the processing device 200_1. The ink jet printer 100_2 is communicatively connected to the processing device 200_2. The ink jet printer 100_3 is communicatively connected to the processing device 200_3. In this way, the ink jet printers 100_1 to 100_3 correspond to the processing devices 200_1 to 200_3, respectively, and are communicably connected to the processing devices 200_1 to 200_3, respectively. In the following description, the processing devices 200_1 to 200_3 may be collectively referred to as a processing device 200 without distinction.

Also, hereinafter, a recording system 20_i may be described for each integer i from 1 to 3. The recording system 20_i includes at least an ink jet printer 100_i and a processing device 200_i. In the following description, the recording systems 20_1 to 20_3 may be collectively referred to as a recording system 20 without distinction. It can also be said that the ink jet system 10 includes the recording systems 20_1 to 20_3 and the server 300. In the example of FIG. 1, the recording system 20_1 includes the ink jet printer 100_1 and the processing device 200_1. The recording system 20_2 includes the ink jet printer 100_2 and the processing device 200_2. The recording system 20_3 includes the ink jet printer 100_3, the processing device 200_3, and the mobile terminal 700.

In the example shown in FIG. 1, the ink jet system 10 includes three ink jet printers 100 and three processing devices 200, but the number is not limited to three, and may be one, two, or four or more. That is, the number of pairs of the ink jet printer 100 and the processing device 200 is not limited to three, and may be one, two, or four or more.

The ink jet printer 100 receives a recording job JB for executing a recording process from the processing device 200. The recording job JB includes identification information (not shown) that uniquely identifies the recording job JB, and recording data DP that indicates an image to be formed on the recording medium PP. Furthermore, the recording job JB may include information indicating the number of print copies of the image to be formed on the recording medium PP. The recording job JB is generated by the processing device 200 when the processing device 200 is notified of a recording instruction PI by the operation by the user U. The recording instruction PI includes information identifying image data that is the source of the recording data DP is based. The image data is data in a file format such as PostScript, PDF, or XPS. PDF is an abbreviation for Portable Document Format. XPS is an abbreviation for XML Paper Specification. The information identifying the image data is, for example, the file path of the image data stored in the processing device 200. The ink jet printer 100 forms an image based on the recording data DP on the recording medium PP.

Note that in the example of FIG. 1, as a result of the user U_1 operating the ink jet printer 100_1, the ink jet printer 100_1 notifies the processing device 200_1 of the recording instruction PI, but the present disclosure is not limited to this. For example, when the user U_1 operates the processing device 200_1, the processing device 200_1 may generate the recording instruction PI, and the processing device 200_1 may generate the recording job JB based on the generated recording instruction PI.

The recording medium PP is not particularly limited as long as it is a medium on which the ink jet printer 100 can perform printing, and examples thereof include various types of paper, various types of cloth, and various types of films.

The ink jet printer 100 has one head unit HU. In the following description, the head unit HU ejects ink from nozzles Nz provided in the head unit HU. Hereinafter, the elements constituting the ink jet printer 100 excluding the head unit HU may be referred to as a “printer main body”.

In the example shown in FIG. 1, the ink jet printer 100 has one head unit HU, but the number of the head units HU is not limited to one, and may be two or more.

The processing device 200 is a desktop or notebook computer. The processing device 200 executes an image process for generating the recording data DP and a process for controlling printing by the ink jet printer 100. In the image process, the processing device 200 generates the recording data DP by executing various types of processes such as a color conversion process and a RIP process on image data in file formats such as PostScript, PDF, and XPS as described above. RIP is an abbreviation for Raster image processor. The image data in the file format is, for example, data that the user U instructs the object on which the recording operation is to be performed. The color conversion process is a process for converting RGB values represented by image data in a file format into CMYK values, CMY values, or the like, which are colors of ink used by the ink jet printer 100 with reference to a lookup table. In the following description, an example of conversion to CMY values will be used. The lookup table defines the correspondence between RGB values and CMY values. The RIP process is a process for generating the recording data DP, which is data with which the ink jet printer 100 can perform printing, using information indicating a dither pattern and information indicating an error diffusion matrix.

The mobile terminal 700 is a portable terminal used by the user U, such as a smartphone, a tablet terminal, or the like. In the example of FIG. 1, the mobile terminal 700 is operated by the user U_3. Note that the mobile terminal 700 is an example of a “terminal device”. However, the terminal device is not limited to a portable terminal such as the mobile terminal 700, and may be, for example, a notebook computer.

The processing device 200 is communicably connected to the server 300 via a network NW such as a LAN, a WAN, and the Internet. LAN is an abbreviation for Local Area Network. WAN is an abbreviation for Wide Area Network.

The server 300 is a computer that functions as a cloud server CS, which will be described later. The server 300 is managed by a business operator different from, for example, a head manufacturer, a printer manufacturer, and an end user. Hereinafter, the business operator that manages the server 300 may be referred to as a “server business operator”. The head manufacturer uses part of the server 300.

### 1-2. Configuration of Server 300

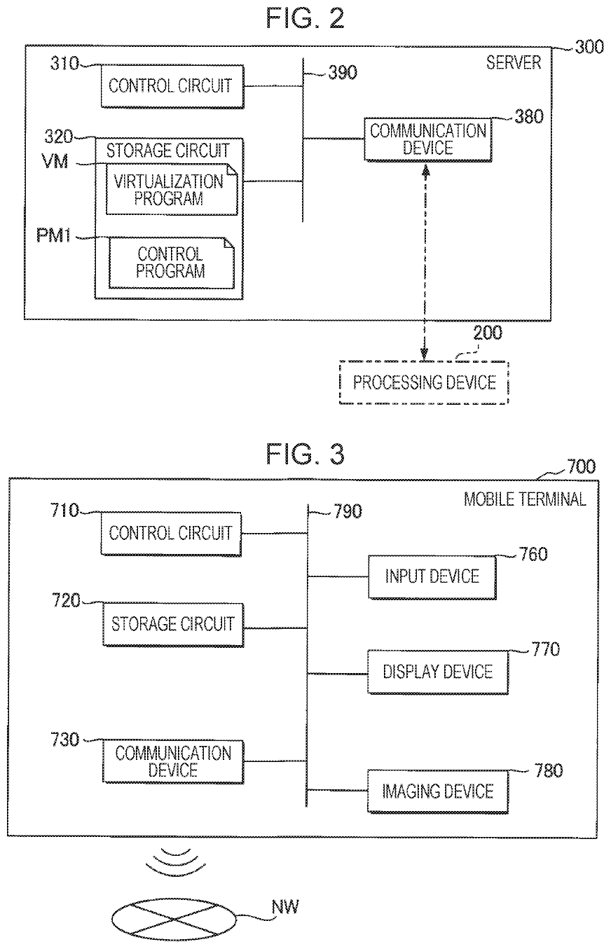

FIG. 2 is a diagram showing an example of the configuration of the server 300. The server 300 has a control circuit 310, a storage circuit 320 and a communication device 380. The control circuit 310, the storage circuit 320, and the communication device 380 are interconnected by a bus 390 for communicating information.

The control circuit 310 includes a processor, such as, for example, one or more CPUs. CPU is an abbreviation for Central Processing Unit. Note that the control circuit 310 may include a programmable logic device such as an FPGA instead of or in addition to the CPU. FPGA is an abbreviation for Field Programmable Gate Array.

The storage circuit 320 is composed of a magnetic storage device, a flash ROM, or the like. The storage circuit 320 stores a plurality of programs including a virtualization program VM and a control program PM1 readable by the control circuit 310 and executed by the control circuit 310, various pieces of information used by the control circuit 310, and the like. The virtualization program VM divides resources such as the control circuit 310 and the storage circuit 320 of the server 300 into a plurality of resources, and operates each of the divided resources as a virtual server. The head manufacturer uses one of the plurality of virtual servers as the cloud server CS as part of the server 300. The control program PM1 is developed by the head manufacturer.

However, the storage circuit 320 may not have the virtualization program VM, and the processing device 200 may access the server 300 instead of the cloud server CS.

The communication device 380 is hardware having a communication circuit for communicating with other devices such as respective devices in a recording system 20 via the network NW. The communication device 380 is also referred to as a network device, network controller, network card, or communication module, for example.

### 1-3. Configuration of Mobile Terminal 700

FIG. 3 is a diagram showing the configuration of the mobile terminal 700. Mobile terminal 700 includes a control circuit 710, a storage circuit 720, a communication device 730, an input device 760, a display device 270, and an imaging device 780. The control circuit 710, the storage circuit 720, the communication device 730, the input device 760, a display device 770, and the imaging device 780 are mutually coupled by a bus 790 for communicating information.

The control circuit 710 includes a processor, such as, for example, one or more CPUs. Note that the control circuit 710 may include a programmable logic device such as an FPGA instead of or in addition to the CPU.

The storage circuit 720 is composed of a magnetic storage device, a flash ROM, or the like. The storage circuit 720 stores programs readable by the control circuit 710 and executed by the control circuit 710 and various pieces of information used by the control circuit 710. The storage circuit 720 includes, for example, semiconductor memory of one or both of one or a plurality of volatile memories such as a RAM and one or a plurality of nonvolatile memories such as a ROM, an EEPROM or a PROM.

The communication device 730 is hardware having a communication circuit for performing wireless communication with other devices such as the server 300 via the network NW.

The input device 760 is a device that outputs operation information according to the operation by the user U. The input device 760 is, for example, a keyboard.

The display device 770 displays to the user U an image showing some information. The display device 770 includes an organic EL display, an LED display, or an LCD. EL is an abbreviation for Electro-Luminescence. LED is an abbreviation for Light Emitting Diode. LCD is an abbreviation for Liquid Crystal Display. Alternatively, the input device 760 and the display device 770 may be integrated. A configuration in which the input device 760 and the display device 770 are integrated is, for example, a touch panel.

The imaging device 780 includes, for example, an imaging optical system and an imaging element. The imaging optical system is an optical system including at least one imaging lens, and may include various optical elements such as a prism, or may include a zoom lens, a focus lens, or the like. The imaging element is, for example, a CCD image sensor or a CMOS image sensor. CCD is an abbreviation for Charge Coupled Device. CMOS is an abbreviation for complementary MOS.

### 1-4. Configuration of Processing Device 200

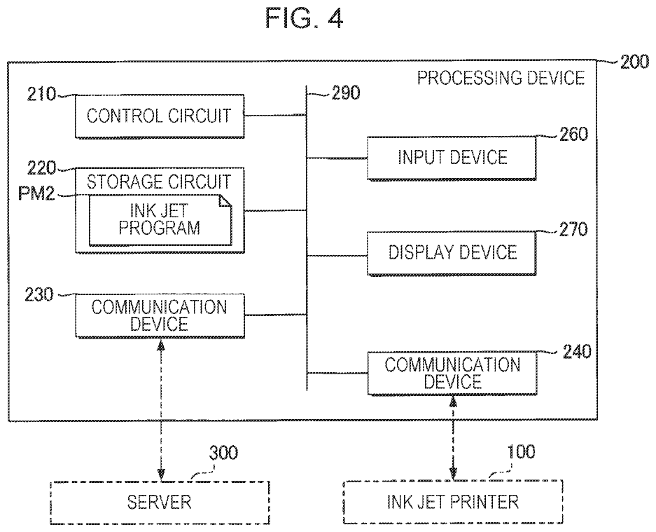

FIG. 4 is a diagram showing the configuration of the processing device 200. The processing device 200 includes a control circuit 210, a storage circuit 220, a communication device 230, an input device 260, and the display device 270. The control circuit 210, the storage circuit 220, the communication device 230, the input device 260, and the display device 270 are interconnected by a bus 290 for communicating information.

The control circuit 210 includes a processor, such as, for example, one or more CPUs. Note that the control circuit 210 may include a programmable logic device such as an FPGA instead of or in addition to the CPU.

The storage circuit 220 is composed of a magnetic storage device, a flash ROM, or the like. The storage circuit 220 stores a plurality of programs including an ink jet program PM2 readable by the control circuit 210, and executed by the control circuit 210, various pieces of information used by the control circuit 210, and the like. The storage circuit 220 includes, for example, semiconductor memory of one or both of one or a plurality of volatile memories such as a RAM and one or a plurality of nonvolatile memories such as a ROM, an EEPROM or a PROM. The ink jet program PM2 is downloaded from the cloud server CS operating on the server 300 and installed in the processing device 200 when the processing device 200 is connected to the ink jet printer 100, for example.

The communication device 230 is hardware having a communication circuit for communicating with the processing device 200 via the network NW. The communication device 230 is also referred to as a network device, network controller, network card, or communication module, for example.

A communication device 240 is a circuit capable of communicating with the ink jet printer 100. For example, the communication device 240 is a network card such as USB or Bluetooth. USB is an abbreviation for Universal Serial Bus. USB and Bluetooth are registered trademarks. Generally, the communication speed between the processing device 200 and the server 300 is slower than the communication speed between the processing device 200 and the ink jet printer 100.

The input device 260 is a device that outputs operation information according to the operation by the user U. Input device 260 includes, for example, a mouse and a keyboard.

The display device 270 displays to the user U an image showing some information. The display device 270 includes an organic EL display, an LED display, or an LCD. EL is an abbreviation for Electro-Luminescence. LED is an abbreviation for Light Emitting Diode. LCD is an abbreviation for Liquid Crystal Display. Alternatively, the input device 260 and the display device 270 may be integrated. A configuration in which the input device 260 and the display device 270 are integrated is, for example, a touch panel.

### 1-5. Configuration of Ink Jet Printer 100

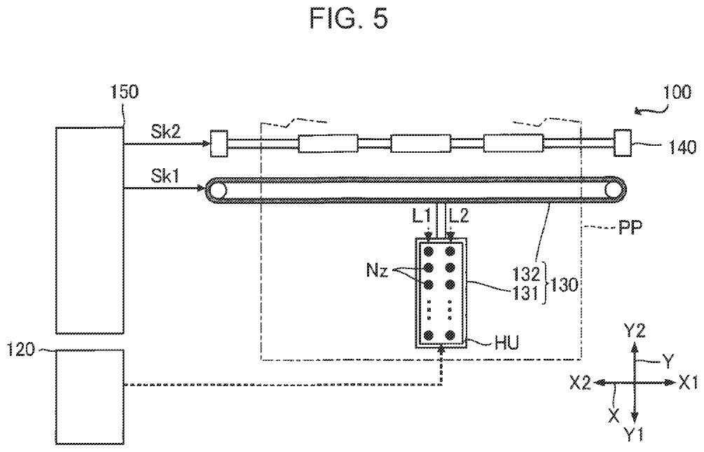

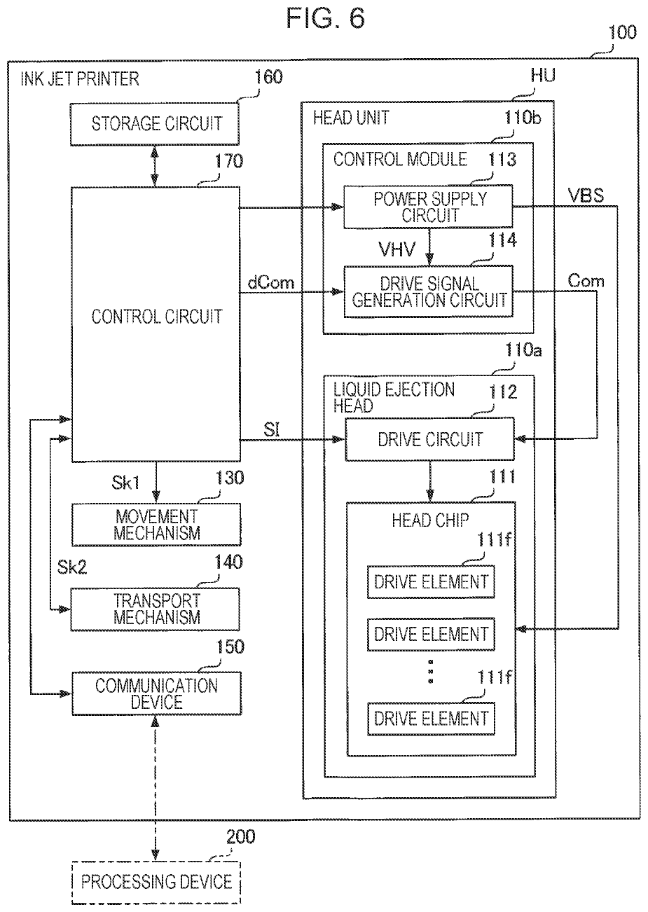

FIG. 5 is a schematic diagram illustrating an example of the configuration of the ink jet printer 100. FIG. 6 is a block diagram showing a configuration example of the ink jet printer 100. The X axis, the Y axis, and the Z axis that are mutually orthogonal to each other are assumed in the following description. One direction along the X axis when viewed from an any point is denoted as an X1 direction, and a direction opposite to the X1 direction is denoted as an X2 direction. Similarly, mutually opposite directions along the Y axis from an any point are denoted as a Y1 direction and a Y2 direction, and mutually opposite directions along the Z axis from an any point are denoted as a Z1 direction and a Z2 direction. The X-Y plane, which includes the X axis and the Y axis, corresponds to the horizontal plane. The Z axis is an axis along the vertical direction, and the Z2 direction corresponds to the downward direction in the vertical direction.

The ink jet printer 100 according to the first embodiment is a serial printer that forms an image on the recording medium PP by a multi-pass method. The multi-pass method refers to forming an image on the recording medium PP by scanning a plurality of times. Specifically, as shown in FIG. 5, the ink jet printer 100 according to the first embodiment transports the recording medium PP in the Y1 direction, which is the sub-scanning direction, and executes a recording operation for forming an image on the recording medium PP by ejecting ink from the nozzles Nz, while moving the head unit HU in the X1 direction and in the X2 direction, which are the main scanning direction. FIG. 5 representatively illustrates some nozzles Nz of the plurality of nozzles Nz of the head unit HU.

As shown in FIGS. 5 and 6, the ink jet printer 100 includes the head unit HU, a liquid container 120, a movement mechanism 130, a transport mechanism 140, a communication device 150, a storage circuit 160, a control circuit 170.

The head unit HU is an assembly includes a head chip 111, a drive circuit 112, a power supply circuit 113, and a drive signal generation circuit 114.

In the example shown in FIG. 5, the head unit HU is divided into a liquid ejection head 110a including the head chip 111 and the drive circuit 112, and a control module 110b including the power supply circuit 113 and the drive signal generation circuit 114. The head unit HU is not limited to the aspect in which the unit is divided into the liquid ejection head 110a and the control module 110b. For example, part or all of the control module 110b may be incorporated into the liquid ejection head 110a.

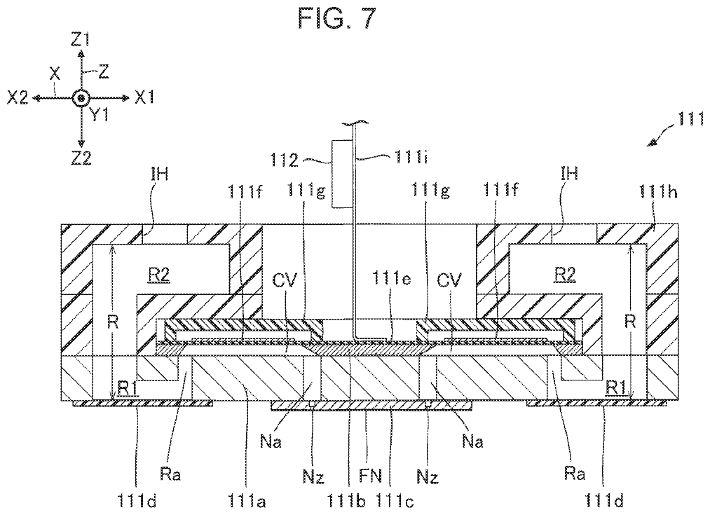

The head chip 111 ejects ink toward the recording medium PP. In FIG. 5, among the components of the head chip 111, a plurality of drive elements 111f is representatively illustrated. An example of details of the head chip 111 will be described later with reference to FIG. 7.

In the example shown in FIG. 6, the number of the head chips 111 included in the head unit HU is one, but the number may be two or more. One or more head chips 111 are disposed so that a plurality of nozzles Nz is distributed over part of the width direction of the recording medium PP.

Under the control of the control circuit 170, the drive circuit 112 switches whether to supply a drive signal Com output from the drive signal generation circuit 114 to each of the plurality of drive elements 111f of the head chip 111. The drive circuit 112 includes, for example, a group of switches such as transmission gates for the switching.

The power supply circuit 113 receives power from a commercial power supply (not shown) and generates various predetermined potentials. The generated various potentials are appropriately supplied to respective components of the ink jet printer 100. In the example shown in FIG. 6, the power supply circuit 113 generates power supply potential VHV and offset potential VBS. The offset potential VBS is supplied to the head chip 111 and the like. In addition, the power supply potential VHV is supplied to the drive signal generation circuit 114 and the like.

The drive signal generation circuit 114 is a circuit that generates the drive signal Com for driving each drive element 111f of the head chip 111. Specifically, the drive signal generation circuit 114 includes, for example, a DA conversion circuit and an amplifier circuit. In the drive signal generation circuit 114, the DA conversion circuit converts a waveform designation signal dCom to be later described from the control circuit 170 from a digital signal to an analog signal, and the amplifier circuit amplifies the analog signal using the power supply potential VHV from the power supply circuit 113 to generate the drive signal Com.

As illustrated in FIG. 5, the ink jet printer 100 includes the liquid container 120 that stores ink. For example, a cartridge that is attachable to and detachable from the ink jet printer 100, a bag-shaped ink pack formed of a flexible film, or an ink tank that can be refilled with ink is used as the liquid container 120.

Under the control of the control circuit 170, the movement mechanism 130 and the transport mechanism 140 move the relative positions of the recording medium PP and the head unit HU. Moving the relative position may mean moving the head unit HU while fixing the position of the recording medium PP, or moving the recording medium PP while fixing the position of the head unit HU. In the present embodiment, in the direction along the X axis, which is the main scanning direction, the head unit HU is moved in the direction along the X axis while the position of the recording medium PP on the X axis is fixed, and in the Y1 direction, which is the sub-scanning direction, the recording medium PP is moved in the Y1 direction while the position of the head unit HU on the Y axis is fixed.

The movement mechanism 130 reciprocates the head unit HU along the X axis under the control of the control circuit 170. As shown in FIG. 5, the movement mechanism 130 includes a substantially box-shaped carriage 131 that houses the head unit HU, and an endless belt 132 to which the head unit HU is fixed. A configuration in which the liquid container 120 together with the head unit HU is mounted on the carriage 131 may also be used.

The transport mechanism 140 transports the recording medium PP in the Y1 direction under the control of the control circuit 170. Specifically, the transport mechanism 140 includes a transport roller (not shown) whose rotation axis is parallel to the X axis, and a motor (not shown) that rotates the transport roller under the control of the control circuit 170.

The communication device 150 is a circuit capable of communicating with the processing device 200. For example, the communication device 150 is a network card such as USB or Bluetooth. Also, the communication device 150 may be integrated with the control circuit 170.

The storage circuit 160 stores various programs executed by the control circuit 170 and various pieces of data such as the recording job JB processed by the control circuit 170. The storage circuit 160 includes, for example, semiconductor memory of one or both of one or a plurality of volatile memories such as a RAM and one or a plurality of nonvolatile memories such as a ROM, an EEPROM or a PROM. Note that the storage circuit 160 may be configured as part of the control circuit 170.

The control circuit 170 has a function of controlling the operation of each component of the ink jet printer 100 and a function of processing various pieces of data. The control circuit 170 includes, for example, a processor, such as one or more CPUs. Note that the control circuit 170 may include a programmable logic device such as an FPGA instead of or in addition to the CPU.

The control circuit 170 controls the operation of each component of the ink jet printer 100 by executing programs stored in the storage circuit 160. Here, the control circuit 170 generates signals such as a control signal Sk1, a control signal Sk2, a print signal SI, and the waveform designation signal dCom as signals for controlling the operation of each component of the ink jet printer 100.

The control signal Sk1 is a signal for controlling driving of the movement mechanism 130. The control signal Sk2 is a signal for controlling driving of the transport mechanism 140. The print signal SI is a signal for controlling driving of the drive circuit 112. Specifically, the print signal SI designates for each predetermined unit period whether the drive circuit 112 supplies the drive signal Com from the drive signal generation circuit 114 to the drive element 111f. By this designation, the amount of ink ejected from the head chip 111 and the like are designated. The waveform designation signal dCom is a digital signal for defining the waveform of the drive signal Com generated by the drive signal generation circuit 114.

When the recording operation is executed, the control circuit 170 first causes the storage circuit 160 to store the recording job JB supplied from the processing device 200. Next, the control circuit 170 generates various control signals such as the print signal SI, the waveform designation signal dCom, the control signal Sk1, and the control signal Sk2 based on various pieces of data such as the recording data DP included in the recording job JB stored in the storage circuit 160. Based on various control signals and various pieces of data stored in the storage circuit 160, the control circuit 170 controls the transport mechanism 140 and the movement mechanism 130 so as to change the relative position of the recording medium PP with respect to the head unit HU, and controls the head unit HU so that the drive element 111f is driven. Accordingly, the control circuit 170 adjusts the presence or absence of ink ejection from the drive element 111f, the amount of ink ejected, the ejection timing of ink, and the like, and controls the execution of the recording operation of forming an image based on the recording data DP on the recording medium PP.

FIG. 7 is a cross-sectional view showing a configuration example of the head chip 111. In the following description, X axis, Y axis and Z axis that intersect with each other are appropriately used. Hereinafter, one direction along the X axis is the X1 direction, and a direction opposite to the X1 direction is the X2 direction. Similarly, the directions opposite to each other along the Y axis are the Y1 direction and the Y2 direction. The directions opposite to each other along the Z axis are the Z1 direction and the Z2 direction.

As shown in FIGS. 5 and 7, the head chip 111 has a plurality of nozzles Nz disposed along the Y axis. As shown in FIG. 5, the plurality of nozzles Nz is divided into a first row L1 and a second row L2 spaced apart from each other in the direction along the X axis. Each of the first row L1 and the second row L2 is a set of a plurality of nozzles Nz linearly disposed in the direction along the Y axis.

The head chips 111 are substantially symmetrical to each other in the direction along the X axis. However, the positions of the plurality of nozzles Nz in the first row L1 and the positions of the plurality of nozzles Nz in the second row L2 in the direction along the Y axis may be the same or different. FIG. 7 illustrates a configuration in which the positions of the plurality of nozzles Nz of the first row L1 and the positions of the plurality of nozzles Nz of the second row L2 in the direction along the Y axis are the same.

As shown in FIG. 7, the head chip 111 includes a flow path substrate 111a, a pressure chamber substrate 111b, a nozzle plate 111c, a vibration absorber 111d, a vibration plate 111e, a plurality of drive elements 111f, a protection plate 111g, a case 111h, and a wiring substrate 111i.

The flow path substrate 111a and the pressure chamber substrate 111b are stacked in this order in the Z1 direction to form flow paths for supplying ink to the plurality of nozzles Nz. The vibration plate 111e, the plurality of drive elements 111f, the protection plate 111g, the case 111h, and the wiring substrate 111i are installed in a region located in the Z1 direction relative to the laminate composed of the flow path substrate 111a and the pressure chamber substrate 111b. On the other hand, the nozzle plate 111c and the vibration absorber 111d are installed in a region located in the Z2 direction relative to the laminate. Respective components of the head chip 111 are generally plate-shaped members elongated in the Y direction, and are bonded to each other with an adhesive, for example. The components of the head chip 111 will be described in order below.

The nozzle plate 111c is a plate-shaped member provided with a plurality of nozzles Nz for each of the first row L1 and the second row L2. Each of the plurality of nozzles Nz is a through hole through which ink passes. Here, the face, of the nozzle plate 111c, facing the Z2 direction is a nozzle face FN. The nozzle plate 111c is manufactured, for example, by processing a silicon single crystal substrate by a semiconductor manufacturing technique using a processing technique such as dry etching or wet etching. However, other known methods and materials may be used as appropriate for manufacturing the nozzle plate 111c. In addition, the cross-sectional shape of the nozzle Nz is typically circular, but is not limited to this, and may be non-circular such as polygonal or elliptical.

The flow path substrate 111a is provided with a space R1, a plurality of supply flow paths Ra, and a plurality of communication flow paths Na for each of the first row L1 and the second row L2. The space R1 is an elongated opening extending in the direction along the Y axis in plan view along the Z axis. Each of the supply flow path Ra and the communication flow path Na is a through hole formed for a nozzle Nz. Each supply flow path Ra communicates with the space R1.

The pressure chamber substrate 111b is a plate-shaped member provided with a plurality of pressure chambers CV called cavities for each of the first row L1 and the second row L2. The plurality of pressure chambers CV is disposed in a direction along the Y axis. Each pressure chamber CV is an elongated space formed for a nozzle Nz and extending in the direction along the X axis in plan view. In the same manner as the nozzle plate 111c described above, each of the flow path substrate 111a and the pressure chamber substrate 111b is manufactured, for example, by processing a silicon single crystal substrate by a semiconductor manufacturing technique. However, other known methods and materials may be appropriately used for manufacturing the flow path substrate 111a and the pressure chamber substrate 111b.

The pressure chamber CV is a space located between the flow path substrate 111a and the vibration plate 111e. The plurality of pressure chambers CV is disposed in the direction along the Y axis for each of the first row L1 and the second row L2. Further, the pressure chamber CV communicates with each of the communication flow path Na and the supply flow path Ra. Therefore, the pressure chamber CV communicates with the nozzle Nz via the communication flow path Na and communicates with the space R1 via the supply flow path Ra.

The vibration plate 111e is disposed on the face, of the pressure chamber substrate 111b, facing the Z1 direction. The vibration plate 111e is a plate-shaped member that can vibrate elastically. The vibration plate 111e has, for example, a first layer and a second layer, which are stacked in this order in the Z1 direction. The first layer is, for example, an elastic film made of silicon oxide (SiO₂). The elastic film is formed, for example, by thermally oxidizing one face of a silicon single crystal substrate. The second layer is an insulating film made of, for example, zirconium oxide (ZrO₂). The insulating film is formed, for example, by forming a zirconium layer by sputtering and thermally oxidizing the layer. Note that the vibration plate 111e is not limited to the lamination of the first layer and the second layer described above, and may be composed of a single layer or three or more layers, for example.

The plurality of drive elements 111f corresponding to the nozzles Nz is disposed for each of the first row L1 and the second row L2 on the face, of the vibration plate 111e, facing the Z1 direction. Each drive element 111f is a passive element that deforms when supplied with the drive signal Com. Each drive element 111f has an elongated shape extending in the direction along the X axis in plan view. The plurality of drive elements 111f is disposed in a direction along the Y axis so as to correspond to the plurality of pressure chambers CV. The drive element 111f overlaps the pressure chamber CV in plan view.

Each drive element 111f is a piezoelectric element and includes a first electrode, a piezoelectric body layer and a second electrode (not shown), which are stacked in this order in the Z1 direction. One electrode of the first electrode and the second electrode is an individual electrode that is spaced apart from each other for each drive element 111f, and the one electrode is supplied with the drive signal Com. The other electrode of the first electrode and the second electrode is a band-shaped common electrode that extends in the direction along the Y axis so as to be continuous over the plurality of drive elements 111f, and the other electrode is supplied with the offset potential VBS. Examples of metal materials for these electrodes include metal materials such as platinum (Pt), aluminum (Al), nickel (Ni), gold (Au), and copper (Cu). They can be used alone or in combination of two or more in the form of an alloy, lamination, or the like. The piezoelectric body layer is made of a piezoelectric material such as lead zirconate titanate (Pb(Zr, Ti)O3) and has a band shape extending in the direction along the Y axis so as to be continuous over the plurality of drive elements 111f, for example. However, the piezoelectric body layer may be integrated over the plurality of drive elements 111f. In this case, the piezoelectric body layer is provided with a through hole extending in the direction along the X axis and penetrating through the piezoelectric body layer in a region corresponding to the gap between the pressure chambers CV adjacent to each other in plan view. When the vibration plate 111e vibrates in association with the deformation of the drive element 111f, the pressure in the pressure chamber CV fluctuates, and ink is ejected from the nozzle Nz.

The protection plate 111g is a plate-shaped member installed on the face, of the vibration plate 111e, facing the Z1 direction, and protects the plurality of drive elements 111f and reinforces the mechanical strength of the vibration plate 111e. Here, a plurality of drive elements 111f is accommodated between the protection plate 111g and the vibration plate 111e. The protection plate 111g is made of a resin material, for example.

The case 111h is a member for storing ink supplied to the plurality of pressure chambers CV. The case 111h is made of, for example, a resin material. The case 111h has a space R2 for each of the first row L1 and the second row L2. The space R2 is a space that communicates with the aforementioned space R1, and functions together with the space R1 as a reservoir R that stores ink supplied to each of the plurality of pressure chambers CV. The case 111h has an introduction port IH for supplying ink to each reservoir R. The ink in each reservoir R is supplied to the pressure chamber CV through each supply flow path Ra.

The vibration absorber 111d, which is also referred to as a compliance substrate, is a flexible resin film forming a wall face of the reservoir R, and absorbs pressure fluctuations of the ink in the reservoir R. Note that the vibration absorber 111d may be a flexible thin plate made of metal. The face, of the vibration absorber 111d, facing the Z1 direction is bonded to the flow path substrate 111a with an adhesive or the like.

The wiring substrate 111i is mounted on the face, of the vibration plate 111e, facing the Z1 direction, and is a mounting component for electrically connecting the head chip 111, and the drive circuit 112, the control module 110b, and the like. The wiring substrate 111i is, for example, a flexible wiring substrate such as COF, FPC, or FFC. The aforementioned drive circuit 112 is mounted on the wiring substrate 111i of the present embodiment. COF is an abbreviation for Chip On Film. FPC is an abbreviation for Flexible Printed Circuit. FFC is an abbreviation for Flexible Flat Cable.

### 1-6. Provision of Appropriate Control Information CI

There is a business model in which the head manufacturer provides the printer manufacturer with the head unit HU, and the printer manufacturer builds the head unit HU into the printer main body to manufacture the ink jet printer 100. In this business model, printer manufacturers generally design and manufacture components other than the head unit HU. Furthermore, in this business model, the condition in environment in which the head unit HU is used during recording operations differs depending on the printer manufacturer and the end user. Hereinafter, the condition in the environment in which the head unit HU is used during the recording operation may be referred to as a “use condition”. Furthermore, to simplify the explanation, the printer manufacturer and the end user may be collectively referred to as a “head user” without distinction.

The use conditions include, for example, the type of ink ejected by the head unit HU, the type of the recording medium PP on which the head unit HU forms an image, the model number of the head unit HU, and the environmental temperature of the head unit HU. Since the head manufacturer does not know the conditions of use of the head user, it is not possible to store appropriate control information CI in the ink jet printer according to the use conditions, unlike the business model where the head manufacturer manufactures ink jet printers. The control information CI is information for controlling the recording operation of the ink jet printer 100. The control information CI is, for example, one or both of information about the drive signal Com supplied to the drive element 111f and information about an image process, which is a data process of generating the recording data DP. In the present embodiment, the control information CI will be described as information about the drive signal Com. When the appropriate control information CI is not used, the ejection characteristic may deteriorate. The ejection characteristic includes one or more of the ink ejection amount and the ink ejection stability. The head user is required to search for the control information CI according to the conditions of use thereof, which significantly increases the load on the head user.

Therefore, it is conceivable that the recording system 20 and the cloud server CS can be coupled, and the head manufacturer constructs a system having a database that stores the control information CI according to a plurality of use conditions in the cloud server CS. In this system, the recording system 20 transmits condition information UI regarding use conditions to the cloud server CS, and the cloud server CS transmits the control information CI according to the condition information UI to the recording system 20. According to this system, even when the head manufacturer and head user are different, it is possible to provide the appropriate control information CI while reducing the load on the head user, so that the ejection characteristic can be maintained.

However, in providing the above system, it has been found that the following problems occur. The conditions of use of head users were far more diverse than those assumed by head manufacturers. For example, the type of ink and the type of recording medium PP used differ between head users, which was beyond the range expected by the head manufacturer. Therefore, the use conditions that the head manufacturer has anticipated and prepared in advance may be completely different from the conditions of use of the head user, and as a result, there is a possibility that the cloud server CS will not be able to provide the appropriate control information CI. Furthermore, since the conditions of use of head users are much more diverse than the use conditions assumed by head manufacturers, it has been difficult for a head manufacturer alone to provide a system that covers the conditions of use of head users.

Therefore, the conditions of use of the head user, the ejection characteristic obtained using the control information CI provided according to the conditions of use, and the evaluation by the head user are fed back to the head user and are reflected in the above-mentioned database, so that an aspect in which the system is optimized is conceivable. However, in this aspect, the head user feels that there is no psychological benefit in providing their own use conditions, the ejection characteristic, and the evaluation by the head user to the head manufacturer, so that it is conceivable that the head user does not provide the use conditions, the ejection characteristic and the evaluation by the head user. As a result, the head manufacturer may not be able to optimize the above-mentioned system and may not be able to provide the appropriate control information CI to the head user.

Therefore, in the present embodiment, the user U who is the head user is granted a reward for providing the use conditions, the ejection characteristic, and the evaluation by the user U. By granting a reward to the user U, there will be a merit for providing the use conditions, the ejection characteristic, and the evaluation of the head unit HU to the head manufacturer, so that the user U can be motivated to provide the use conditions, the ejection characteristic, and the evaluation by the user U. The head manufacturer can optimize the ink jet system 10 based on the information provided, benefiting both the head user and the head manufacturer.

### 1-7. Function and Operation of Ink Jet System 10

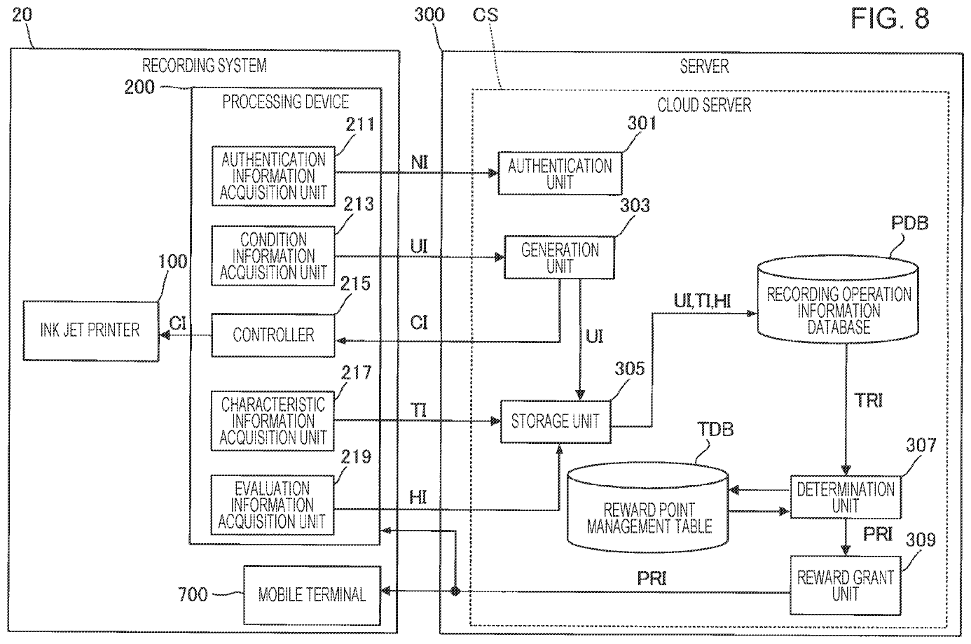

The functions and operations of the ink jet system 10 will be explained using FIGS. 8 to 20.

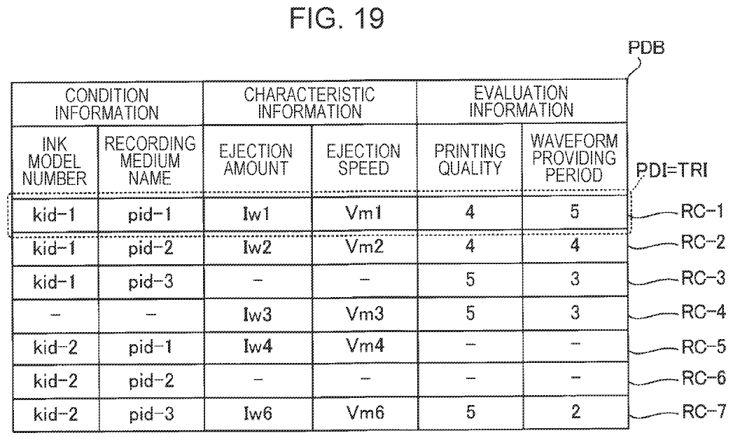

FIG. 8 is a diagram showing the functions of the ink jet system 10. The control circuit 210 functions as an authentication information acquisition unit 211, a condition information acquisition unit 213, a controller 215, a characteristic information acquisition unit 217, and an evaluation information acquisition unit 219 by reading the ink jet program PM2 and executing the read ink jet program PM2. The server 300 functions as the cloud server CS by reading the virtualization program VM and executing the read virtualization program VM. The cloud server CS functions as an authentication unit 301, a generation unit 303, a storage unit 305, a determination unit 307, and a reward grant unit 309 by the cloud server CS reading the control program PM1 and executing the control program PM1. Further, the cloud server CS updates a recording operation information database PDB and a reward point management table TDB by executing the control program PM1. The recording operation information database PDB is a database that accumulates the history of recording operation information PDI. An example of the details of the recording operation information database PDB will be described later with reference to FIG. 19.

The recording operation information PDI includes the condition information UI, characteristic information TI, and evaluation information HI. The characteristic information TI is information about the ejection characteristic of the head unit HU when a recording operation is executed based on the control information CI. The evaluation information HI is information about the evaluation by the user U when the recording operation is executed based on the control information CI. The characteristic information TI and the evaluation information HI will be described later. The recording operation information PDI may not include all of the condition information UI, the characteristic information TI, and the evaluation information HI, but mat include one or two of the condition information UI, the characteristic information TI, and the evaluation information HI.

Moreover, in the following description, information serving as a trigger to provide a reward to the user U is described as trigger information TRI. As described above, the present embodiment aims to give the user U a motivation to provide the conditions of use of the head unit HU, the ejection characteristic of the head unit HU, and the evaluation by the user U, so the trigger information TRI matches the recording operation information PDI. However, the trigger information TRI may be part of the recording operation information PDI, for example, only the characteristic information TI. Further, the trigger information TRI may include information other than part or all of the recording operation information PDI. In the first embodiment, the trigger information TRI will be described as including the condition information UI, the characteristic information TI, and the evaluation information HI.

The reward point management table TDB is a table that stores, for each account of the user U, a score indicating the degree to which the user U has contributed to the ink jet system 10 through the act by the user U of providing the trigger information TRI. Hereinafter, the score indicating the degree to which the user U has contributed to the ink jet system 10 may be referred to as a “reward point”.

Note that the ink jet printer 100 may include an input device and a display device, and function as the authentication information acquisition unit 211, the condition information acquisition unit 213, the controller 215, the characteristic information acquisition unit 217, and the evaluation information acquisition unit 219. Further, in the first embodiment, the processing device 200 is coupled to the cloud server CS, but the ink jet printer 100 may be coupled to the cloud server CS.

In addition, when the server 300 does not function as the cloud server CS, the server 300 may function as the authentication unit 301, the generation unit 303, the storage unit 305, the determination unit 307, and the reward grant unit 309 by the server 300 executing the control program PM1.

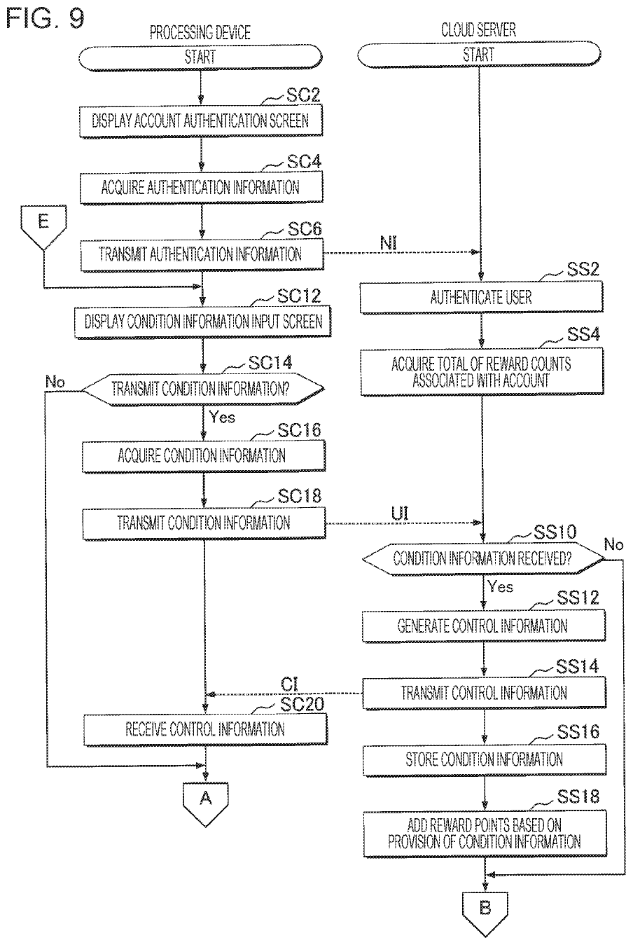

Each functional unit will be explained using the flowcharts shown in FIGS. 9, 10, and 11.

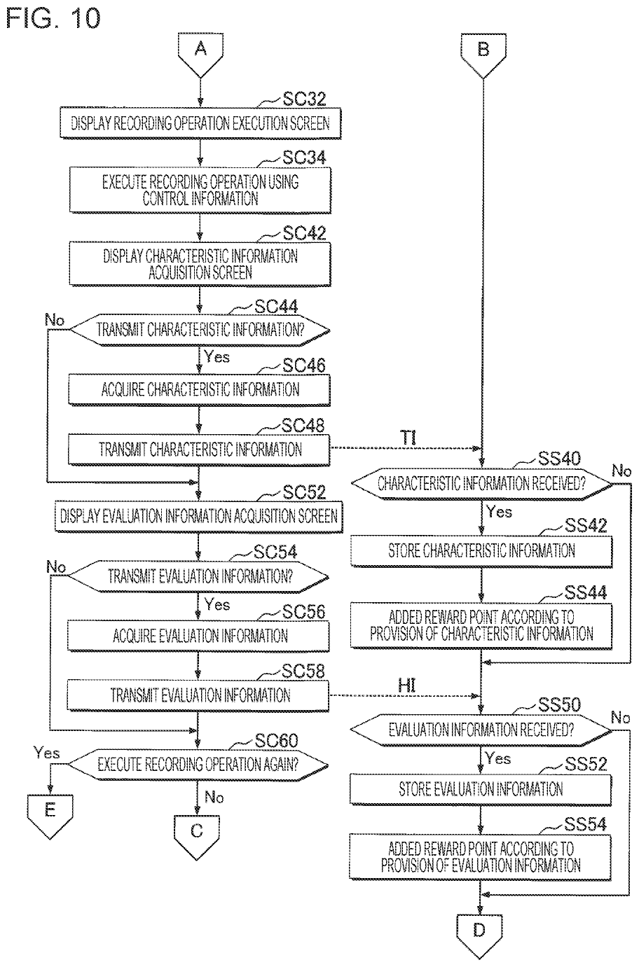

9, FIG. 10, and FIG. 11 are flowcharts showing a series of operations of the ink jet system 10. In step SC2, the processing device 200 display an account authentication screen AW on the display device 270. Next, in step SC4, the processing device 200 functions as the authentication information acquisition unit 211, and the processing device 200 acquires authentication information NI of the user U in order to log in the ink jet system 10. Then, in step SC6, the processing device 200 transmits the acquired authentication information NI to the cloud server CS.

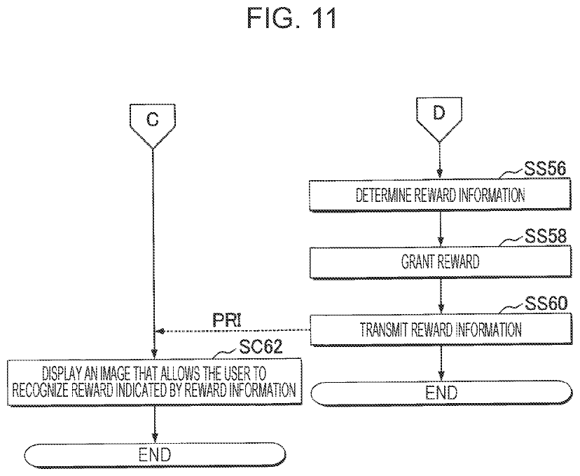

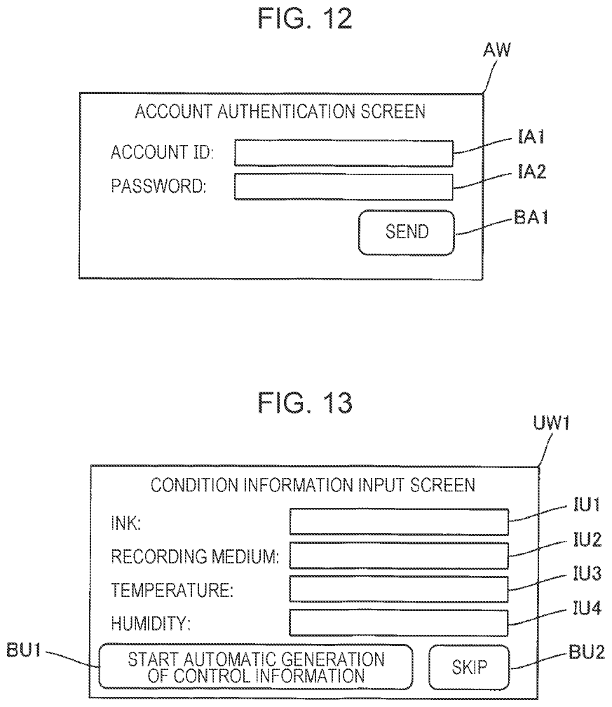

The authentication information NI includes information used to authenticate the user U. Authentication of the user U means confirming that the user U operating the processing device 200 is the user U himself/herself and is not another person impersonating the user. The authentication information NI includes, for example, an account ID and a password. ID is an abbreviation for identifier. A series of processes from step SC2 to step SC6 will be explained using FIG. 12.

FIG. 12 is a diagram showing an example of the account authentication screen AW. Through the process of step SC2, the account authentication screen AW is displayed on the display device 270. The account authentication screen AW includes an input field IA1 where the account ID is input, an input field IA2 where the password is input, and a send button BA1. In step SC4, the processing device 200 acquires a character string input in the input field IA1 as the account ID, and acquires a character string input in the input field IA2 as the password, based on the operation information indicating the operation on the input device 260. When the send button BAL is pressed, the processing device 200 transmits the account ID and the password as the authentication information NI to the cloud server CS in step SC6.

The explanation returns to FIG. 9. When the cloud server CS receives the authentication information NI, the cloud server CS authenticates the user U using the authentication information NI in step SS2. For example, the cloud server CS determines that the authentication is successful when the account ID included in the received authentication information NI matches the account ID stored in the cloud server CS, and the password included in the received authentication information NI matches the password stored in the cloud server CS.

Note that in the above description, the processing device 200 functions as the authentication information acquisition unit 211, but the present disclosure is not limited to this. For example, the mobile terminal 700 may function as the authentication information acquisition unit 211. Further, although the authentication information NI is the account ID and the password, the authentication information NI is not limited to them. For example, the authentication information NI may include the account ID and biometric information, or may further include a one-time password. The biometric information includes, for example, image information showing a fingerprint, image information showing an iris, or image information showing a face. For example, the authentication information acquisition unit 211 may acquire, as the biometric information, a captured image obtained by the imaging device 780 imaging the fingerprint of the user U, the iris of the user U, or the face of the user U.

Furthermore, since the authentication information NI is transmitted via the network NW, it is preferable that the authentication information NI be a cipher text in which the account ID and the password are each encrypted or a hash value obtained by inputting the account ID and the password in a hash function rather than the account ID and password. The hash function is, for example, SHA-256 or SHA-512. SHA is an abbreviation for Secure Hash Algorithm. Similarly, when the authentication information NI is the account ID and the biometric information, it is preferable that the authentication information NI be a cipher text in which the account ID and the biometric information are each encrypted, or a hash value obtained by inputting the account ID and the biometric information into a hash function.

When the cloud server CS fails to authenticate the user U, the cloud server CS transmits information indicating that the authentication of the user U has failed to the processing device 200, and ends the series of processes shown in FIGS. 9, 10, and 11. When the cloud server CS successfully authenticates the user U, in the process of step SS4, the cloud server CS refers to the reward point management table TDB and acquires the total reward points associated with the account of the user U. In the following description, to simplify the explanation, the total number of reward points associated with the account of the user U, which is stored in the reward point management table TDB, may be referred to as “the total of current reward points”.

When the user U causes the ink jet printer 100 to execute a recording operation after successfully authenticating the user U, the processing device 200 displays a condition information input screen UW1 on the display device 270 in step SC12. Next, in step SC14, the processing device 200 determines whether to transmit the condition information UI to the cloud server CS based on the operation by the user U. When the determination result in step SC6 is affirmative, the processing device 200 functions as the condition information acquisition unit 213, acquires the condition information UI in step SC16, and transmits the condition information UI to the cloud server CS in step SC18.

The condition information UI includes one piece of or a plurality of pieces of information of information about the type of the head unit HU, information about the type of ink, information about the type of the recording medium PP, and information about the temperature in the use environment of the head unit HU. The information about the type of the head unit HU is, for example, a character string indicating the model number of the head unit HU or the identification number of the head unit HU. The information about the type of ink is, for example, information indicating ink characteristics, or a name or model number indicating the type of ink. Information indicating ink characteristics is, for example, viscosity. The information about the type of the recording medium PP is information indicating the characteristics of the recording medium PP or a name indicating the type of the recording medium PP. A characteristic of the recording medium PP is, for example, susceptibility to bleeding. The temperature in the use environment of the head unit HU is the so-called environmental temperature. The environmental temperature can be said to be the temperature of the space in which the ink jet printer 100 on which the head unit HU is mounted is installed, or the temperature around the ink jet printer 100. The information about the environmental temperature is, for example, information indicating the temperature in Celsius of the environmental temperature. Note that the condition information UI may include information other than the above information instead of or in addition to the above information. For example, the condition information UI may include one piece of or a plurality of pieces of information about humidity in the use environment of the head unit HU, information about static surface tension or dynamic surface tension of ink, and information about classification of plain paper, coated paper, vinyl chloride sheet, and the like of the recording medium PP.

For example, the condition information acquisition unit 213 acquires the condition information UI by having the user U input each piece of information included in the condition information UI using the input device 260.

A series of processes from step SC12 to step SC18 will be explained using FIG. 13.

FIG. 13 is a diagram showing an example of the condition information input screen UW1. The condition information input screen UW1 is displayed on the display device 270 through the process of step SC12. The condition information UI shown in FIG. 13 includes a name indicating the type of ink, a name indicating the type of recording medium PP, a value indicating the environmental temperature in degrees Celsius, and a value indicating the humidity in the usage environment of the head unit HU. The condition information input screen UW1 includes input fields IU1 to IU4 into which four pieces of information of the condition information UI are input, a button BU1 for starting automatic generation of the control information CI, and a skip button BU2. Under the instruction from the display device 270 and the control circuit 210, character strings or values are displayed in the input fields IU1 to IU4 based on operation information indicating operations on the input device 260. A name indicating the type of ink is input into the input field IU1. A name indicating the type of recording medium PP is input into the input field IU2. A value indicating the environmental temperature in degrees Celsius is input into the input field IU3. A value indicating the humidity in the usage environment of the head unit HU is input into the input field IU4.

When the skip button BU2 is pressed, the processing device 200 does not transmit the condition information UI to the cloud server CS, that is, determines that the determination result in step SC14 is negative.

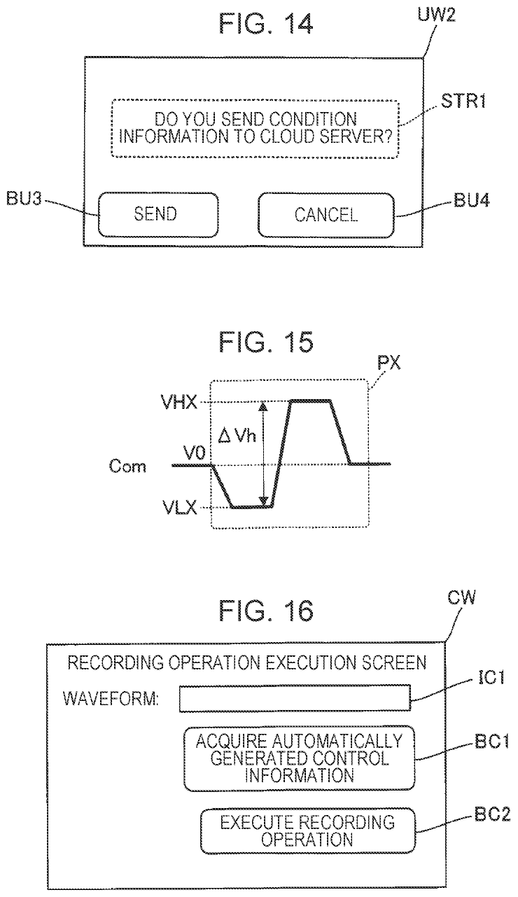

When the button BU1 is pressed, the processing device 200 displays a confirmation dialog UW2 shown in FIG. 14 so as to superimpose the confirmation dialog UW2 on the condition information input screen UW1.

FIG. 14 is a diagram showing an example of the confirmation dialog UW2. The confirmation dialog UW2 includes a character string STR1 indicating whether to transmit the condition information UI to the cloud server CS, a send button BU3, and a cancel button BU4. When the send button BU3 is pressed, the processing device 200 determines in step SC14 that the condition information UI is transmitted to the cloud server CS, that is, determines that the determination result in step SC14 is affirmative. Then, in step SC16, the processing device 200 acquires the character strings or values input into the input fields IU1 to IU4 as each piece of information of the condition information UI. Specifically, the processing device 200 acquires the character string input into the input field IU1 as a name indicating the type of ink. Furthermore, the processing device 200 acquires the character string input into the input field IU2 as a name indicating the type of recording medium PP. The processing device 200 acquires the value input into the input field IU3 as a value indicating the environmental temperature in degrees Celsius. Processing device 200 acquires the value input into input field IU4 as a value indicating the humidity in the usage environment of head unit HU. Then, in step SC18, the processing device 200 transmits the acquired condition information UI to the cloud server CS. When the cancel button BU4 is pressed, the processing device 200 closes the confirmation dialog UW2 and makes it possible to accept input on the condition information input screen UW1.

Note that in the above description, the condition information UI is obtained through input by the user U, but the present disclosure is not limited to this. For example, when the condition information acquisition unit 213 can acquire each piece of information included in the condition information UI from the ink jet printer 100, the condition information acquisition unit 213 may acquire the information from the ink jet printer 100. For example, when the ink jet printer 100 includes a temperature sensor, the condition information acquisition unit 213 acquires, from the ink jet printer 100, a value indicating the temperature measured by the temperature sensor. Furthermore, the mobile terminal 700 may function as the condition information acquisition unit 213. For example, a barcode or two-dimensional code indicating the identification number of the head unit HU may be printed on the side face of the housing of the head unit HU. The mobile terminal 700 captures an image of a barcode or two-dimensional code by the imaging device 780 to according to the operation by the user U. The control circuit 710 in the mobile terminal 700 acquires image information indicating an image captured by the imaging device 780. When the image information is acquired, the control circuit 710 analyzes the image information and acquires the identification number of the head unit HU.

The explanation returns to FIG. 9. In step SS10, the cloud server CS determines whether the condition information UI has been received. When the determination result in step SS10 is affirmative, the cloud server CS functions as the generation unit 303 in step SS12, and generates the control information CI for controlling the recording operation based on the condition information UI. An example of generating the control information CI will be described using FIG. 15.

FIG. 15 is a diagram for describing an example of generating the control information CI. FIG. 15 shows an example of a waveform PX of the drive signal Com. The waveform PX includes a period in which an intermediate potential V0 is maintained, a period in which the potential is lowered from the intermediate potential V0 to a lowest potential VLX, a period in which the lowest potential VLX is maintained, and a period in which the potential is raised from the lowest potential VLX to a highest potential VHX, a period in which the highest potential VHX is maintained, and a period in which the potential is lowered from the highest potential VHX to the intermediate potential V0. The ejection amount can be increased as a potential difference ΔVh between the lowest potential VLX and the highest potential VHX is increased.

When the control information CI is information about the drive signal Com, the control information CI is a parameter regarding the waveform PX of the drive signal Com. The parameter regarding the waveform PX may be, for example, information indicating the shape of the waveform PX, or information indicating one or both of the lowest potential VLX and highest potential VHX. In the following explanation, the control information CI will be explained as information indicating the shape of the waveform PX.

A certain amount of manufacturing error may occur in the head unit HU. Even when a certain predetermined drive signal Com is applied to the head unit HU, the shape of the pressure chamber CV may deviate from the shape assumed by the head manufacturer due to manufacturing errors. As a result, the ejection amount of ink ejected form head unit HU may differ from the predetermined ejection amount specified by the head manufacturer. For example, it is assumed that the information included in the condition information UI is the identification number of the head unit HU. The cloud server CS stores a table showing the amount of ejection of the head unit HU for each identification number of the head unit HU. From the identification number of the head unit HU included in the condition information UI, the generation unit 303 refers to the above-described table, and determines information indicating the shape of the waveform PX having a potential difference ΔVh that offsets the manufacturing error as the control information CI.

Similarly, the ejection amount may vary depending on the type of ink, environmental temperature, and the like. The generation unit 303 generates, as control information CI, information indicating the shape of the waveform PX having the potential difference ΔVh that offsets fluctuations in ejection amount, based on the condition information UI. In addition, the state of the ink after the ink has landed on the recording medium PP may vary depending on the type of the recording medium PP. The generation unit 303 generates, as control information CI, information indicating the shape of the waveform PX having the potential difference ΔVh that offsets fluctuations in the state of the ink, based on the condition information UI.

The explanation returns to FIG. 9. After completing the process in step SS12, the cloud server CS transmits the control information CI to the processing device 200 in step SS14. The processing device 200 receives the control information CI in step SC20.

Note that the generation unit 303 may generate the plurality of pieces of control information CI based on the condition information UI. For example, the generation unit 303 may generate the control information CI for ejecting a normal amount of ink according to the condition information UI, the control information CI for ejecting a larger amount of ink than usual, and the control information CI for ejecting a smaller amount of ink than usual, and may transmit the three pieces of control information CI to the processing device 200.

Further, in step SS16, the cloud server CS functions as the storage unit 305 and stores the condition information UI in the recording operation information database PDB. Continuously, in step SS18, the cloud server CS functions as the determination unit 307 and adds the reward points corresponding to the provision of the condition information UI, which is part of the trigger information TRI, to the total of current reward points. For example, the reward points corresponding to the provision of the condition information UI are lower than the reward points corresponding to the provision of the characteristic information TI, and are lower than the reward points corresponding to the provision of the evaluation information HI. For example, the reward points corresponding to the provision of the condition information UI are +2 points. The cloud server CS updates the reward point management table TDB with a total of added reward points. Note that the cloud server CS may perform the process in step SS16 and step SS18 before the process in step SS12 and step SS14, or may perform the process at the same time.

In FIG. 10, after completing the process in step SC20, the processing device 200 displays, on the display device 270, a recording operation execution screen CW in step SC32. Furthermore, when the skip button BU2 on the condition information input screen UW1 is pressed, that is, when the determination result in step SC14 is negative, the process in step SC32 is executed. The recording operation execution screen CW will be explained using FIG. 16.

FIG. 16 is a diagram showing an example of the recording operation execution screen CW. The recording operation execution screen CW includes an input field IC1 for inputting a numerical value of each component of the waveform PX included in the drive signal Com, which is the control information CI of the first aspect, and a button BC2 for executing the recording operation.

In the input field IC1, for example, the numerical value of each component of the waveform PX can be input. Alternatively, the recording operation execution screen CW may have a button that displays an image indicating the shape of the waveform PX instead of the input field IC1. When this button is pressed, the display device 270 displays an image indicating the shape of the waveform PX. Then, the processing device 200 transforms, for example, the shape of the waveform PX based on the operation information indicating the operation of the input device 260.

When a button BC1 is pressed, the display device 270 displays the numerical value of each component of the waveform PX of the drive signal Com, which is the control information CI received through the process of step SC20, under the instruction of the control circuit 210. Note that when the determination result in step SC14 is negative, the processing device 200 may execute the process in step SC12 again.

Description when the button BC2 is pressed is made after returning to FIG. 10. When the button BC2 is pressed, the control circuit 210 functions as the controller 215 and controls the recording operation of the ink jet printer 100 using the control information CI in step SC34. Specifically, the control circuit 210 transmits the control information CI to the ink jet printer 100. The ink jet printer 100 applies the waveform PX indicated by the control information CI to the drive element 111f to execute a recording operation.

Note that when the ink jet printer 100 is configured to be coupled to the cloud server CS without going through the processing device 200, the cloud server CS may transmit the control information CI to the ink jet printer 100.

Further, when receiving the plurality of pieces of control information CI from the cloud server CS, the processing device 200 may be configured to select one piece of control information CI from the plurality of pieces of control information CI by the operation by the user U. The control circuit 210 transmits the control information CI selected by the user U to the ink jet printer 100.

After completing the process in step SC34, the processing device 200 displays, on the display device 270, a characteristic information acquisition screen TW in step SC42. Next, in step SC44, the processing device 200 determines whether to transmit the characteristic information TI to the cloud server CS based on the operation by the user U. For example, the characteristic information TI includes one piece of or a plurality of pieces of information indicating the amount of ink ejected from the nozzle Nz of the head unit HU, information indicating the ejection speed of the ink ejected from the nozzle Nz, and information indicating the ejection stability of the ink from the nozzle Nz. Ejection stability means the property in which ink ejected from the nozzle Nz lands at the landing position assumed by the head manufacturer. Specifically, this means that the closer to the landing position assumed by the head manufacturer the actual landing position of the ink ejected from the nozzle Nz is, the higher the ejection stability is. When the determination result in step SC44 is affirmative, the processing device 200 functions as the characteristic information acquisition unit 217, acquires the characteristic information TI in step SC46, and transmits the characteristic information TI to the cloud server CS in step SC48.

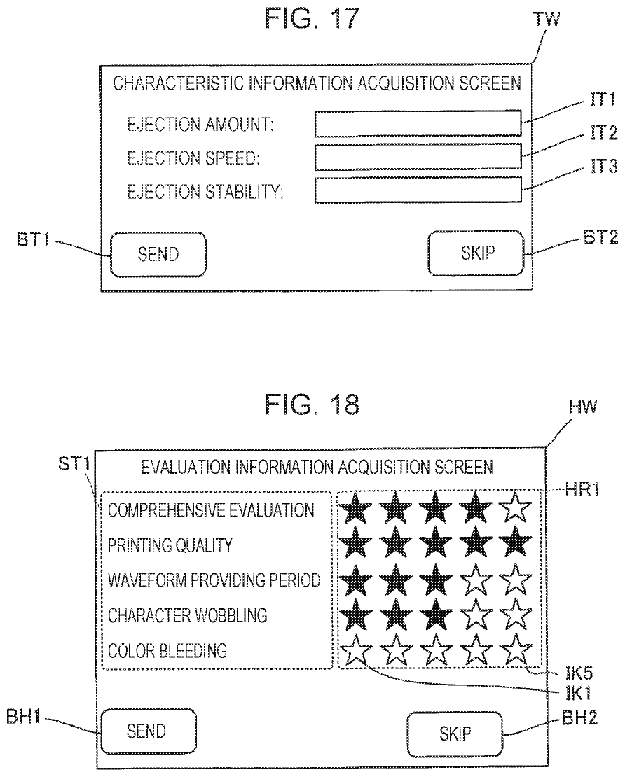

A series of processes from step SC42 to step SC48 will be explained using FIG. 17.

FIG. 17 is a diagram showing an example of the characteristic information acquisition screen TW. The characteristic information acquisition screen TW is displayed on the display device 270 through the process of step SC42. The characteristic information acquisition screen TW includes a region IT1 where a value indicating the ejection amount is displayed, a region IT2 where a value indicating the ejection speed is displayed, a region IT3 where a value indicating the ejection stability is displayed, a send button BT1 for transmitting characteristic information TI, and a skip button BT2.

Information input into the region IT1 and the region IT2 will be explained. In order to acquire one or both of the value indicating the ejection amount and the value indicating the ejection speed, for example, the ink jet printer 100 includes an imaging device installed at a position in the Z2 direction relative to the nozzle Nz in order to capture an image of the ink in the air ejected from the nozzle Nz. The control circuit 210 receives, from the ink jet printer 100, moving image information indicating a moving image captured by the imaging device for a predetermined period of time. Then, the control circuit 210 acquires a value indicating the ejection amount and a value indicating the ejection speed by analyzing the moving image information. The display device 270 displays a value indicating the ejection amount in the region IT1 and a value indicating the ejection speed in the region IT2 according to the instruction from the control circuit 210. Alternatively, the display device 270 may display the moving image indicated by the moving image information acquired from the ink jet printer 100 in the region IT1 or the region IT2 according to the instruction from the control circuit 210.

Information input into the region IT3 will be explained. The value indicating the ejection stability is, for example, the distance from the landing position assumed by the head manufacturer to the actual landing position of the ink ejected from the nozzle Nz. In order to receive information indicating ejection stability, for example, the ink jet printer 100 includes an imaging device that is configured to image the recording medium PP after the ink ejected from each of the plurality of nozzles Nz has landed. The control circuit 210 receives image information indicating an image captured by the imaging device from the ink jet printer 100. Then, the control circuit 210 acquires a value indicating ejection stability by analyzing the image information. The display device 270 displays a value indicating ejection stability in the region IT3 according to the instruction from the control circuit 210. Alternatively, the display device 270 may display an image indicated by the image information acquired from the ink jet printer 100 in the region IT3 according to the instruction from the control circuit 210.

When the skip button BT2 is pressed, the processing device 200 does not transmit the characteristic information TI the cloud server CS, that is, determines that the determination result in step SC44 is negative. Note that when the skip button BT2 is pressed, the processing device 200 may displays, on the display device 270, a confirmation dialog including a character string prompting the user to provide the characteristic information TI. The character string prompting the user to provide the characteristic information TI is, for example, “Is it okay if the reward points will not be increased?”.

When the send button BT1 is pressed, the processing device 200 transmits the characteristic information TI to the cloud server CS, that is, determines that the determination result in step SC44 is affirmative. Then, in step SC46, the processing device 200 acquires the information displayed in the regions IT1 to IT3 as the characteristic information TI, and in step SC48, transmits the characteristic information TI to the cloud server CS.

The explanation returns to FIG. 10. After the process in step SS18 is completed, or when the determination result in step SS10 is negative, the cloud server CS determines in step SS40 whether the characteristic information TI has been received. When the determination result in step SS40 is affirmative, the cloud server CS functions as the storage unit 305 and stores the characteristic information TI in the recording operation information database PDB in step SS42. Subsequently, the cloud server CS functions as the determination unit 307, and in step SS44, adds the reward points corresponding to the provision of the characteristic information TI, which is part of the trigger information TRI, to the total of current reward points. For example, the reward points corresponding to the provision of the characteristic information TI are higher than the reward points corresponding to the provision of the condition information UI, and are higher than the reward points corresponding to the provision of the evaluation information HI. For example, the reward points corresponding to the provision of the characteristic information TI are +5 points. The cloud server CS updates the reward point management table TDB with a total of added reward points.

After completing the process in step SC48, the processing device 200 displays, on the display device 270, an evaluation information acquisition screen HW in step SC52. Furthermore, even when the skip button BT2 on the characteristic information acquisition screen TW is pressed, that is, even when the determination result in step SC44 is negative, the process in step SC52 is executed. Next, in step SC54, the processing device 200 determines whether to transmit the evaluation information HI to the cloud server CS based on the operation by the user U. When the determination result in step SC54 is affirmative, the processing device 200 functions as the evaluation information acquisition unit 219, acquires the evaluation information HI in step SC56, and transmits the evaluation information HI to the cloud server CS in step SC58.

A series of processes from step SC52 to step SC58 will be explained using FIG. 18.

FIG. 18 is a diagram showing an example of the evaluation information acquisition screen HW. The evaluation information acquisition screen HW is displayed on the display device 270 through the process of step SC52. The evaluation information acquisition screen HW includes a character string ST1 indicating each of a plurality of evaluation items, an input region HR1 for individually inputting evaluation results for each of the plurality of evaluation items, a send button BH1 for transmitting the evaluation information HI, and a skip button BH2.

The evaluation information HI shown in FIG. 18 shows five evaluation items as an example of a plurality of evaluation items. However, the number of evaluation items may be one. The five evaluation items shown in FIG. 18 include a comprehensive evaluation, a printing quality, a waveform providing period, character rattling, and color bleeding. The comprehensive evaluation is a comprehensive evaluation regarding the ejection operation. The printing quality is a quality of the image formed on the recording medium pp. The waveform providing period is a period from when the user U instructs the processing device 200 to receive the control information CI until the ejection operation ends. The character rattling is rattling of outlines of characters when the image formed on the recording medium PP includes the characters. The color bleeding is color bleeding of an image formed on the recording medium PP.

However, the evaluation items are not limited to the items described above. For example, the evaluation item may be one or more of a degree of graininess, a degree of banding, brightness, saturation, a degree of redness, a degree of bluishness, and a degree of greenness instead of or in addition to the plurality of items described above. The banding is a streak that occurs when partial images corresponding to adjacent passes are formed.

The input region HR1 is a region where the user U operates the input device 260 to input the evaluation result for each of a plurality of evaluation items. In the example of FIG. 18, it is possible to perform evaluation on each of a plurality of evaluation items in five levels. In the example of FIG. 18, the number of levels of evaluation is 5, but it is not limited to 5 as long as it is 2 or larger.

In the input region HR1, five asterisk icons are displayed for each of a plurality of evaluation items, and the larger the number of blackened icons, the higher the evaluation. In the example of FIG. 18, the comprehensive evaluation indicates the evaluation next to the highest evaluation in five levels, the printing quality indicates the highest evaluation in five level, and the waveform providing period and the character rattling indicate the third evaluation in five levels. For example, when the user U presses an icon IK1 with a mouse, which is an example of the input device 260, the icon IK1 is blacked out, and the color bleeding indicates the lowest evaluation in five level. On the other hand, for example, when the user U presses an icon IK5 with the mouse, the five icons from the icon IK1 to the icon IK5 are blacked out, and the color bleeding indicates the highest evaluation in five level.

When the skip button BH2 is pressed, the processing device 200 does not transmit the evaluation information HI to the cloud server CS, that is, determines that the determination result in step SC54 is negative. Note that when the skip button BH2 is pressed, as in when the skip button BT2 is pressed, the processing device 200 mat display, on the display device 270, a confirmation dialog including a character string prompting the user to provide the evaluation information HI.

When the send button BH1 is pressed, the processing device 200 transmits the evaluation information HI to the cloud server CS, that is, determines that the determination result in step SC54 is affirmative. Then, in step SC56, the processing device 200 acquires the information displayed in the input region HR1 as the evaluation information HI, and in step SC58, transmits the evaluation information HI to the cloud server CS.

The explanation returns to FIG. 10. After completing the process in step SC58, the processing device 200 determines in step SC60 whether to execute the recording operation again. Furthermore, even when the determination result in step SC54 is negative, the processing device 200 executes the process in step SC60. When the determination result in step SC60 is affirmative, the processing device 200 returns the process to step SC12. When the determination result in step SC60 is negative, the processing device 200 waits for a notification from the cloud server CS.

After the process in step SS44 is completed, or when the determination result in step SS40 is negative, the cloud server CS determines in step SS50 whether the evaluation information HI has been received. When the determination result in step SS50 is affirmative, in step SS52, the cloud server CS receives the evaluation information HI, functions as the storage unit 305, and stores the evaluation information HI in the recording operation information database PDB. An example of the details of the recording operation information database PDB will be explained using FIG. 19.

FIG. 19 is a diagram showing an example of the details of the recording operation information database PDB. In the recording operation information database PDB shown in FIG. 19, to simplify the explanation, the condition information UI has a character string indicating the ink model number and a name of the recording medium PP, the characteristic information TI has a value indicating the ink ejection amount and a value indicating the ink ejection speed, and the evaluation information HI has a value indicating the evaluation of the printing quality and a value indicating the evaluation of the waveform providing period.

The cloud server CS stores the condition information UI, the characteristic information TI, and the evaluation information HI obtained when performing one time recording operation as a record RC in association with each other in the recording operation information database PDB. One record RC is recording operation information PDI. Furthermore, as described above, in the present embodiment, the recording operation information PDI matches the trigger information TRI.

The recording operation information database PDB shown in FIG. 19 has records RC-1 to RC-7. The records RC-1, RC-2, and RC-7 indicate the details when the processing device 200 transmits all of the condition information UI, the characteristic information TI, and the evaluation information HI to the cloud server CS in one time recording operation. “-” in the recording operation information database PDB shown in FIG. 19 indicates a state in which no data is stored. Therefore, the record RC-3 indicates the details when the processing device 200 transmits the condition information UI and the evaluation information HI to the cloud server CS, but does not transmit the characteristic information TI, in one time recording operation. The record RC-4 indicates the details when the processing device 200 transmits the characteristic information TI and the evaluation information HI to the cloud server CS, but does not transmit the condition information UI, in one time recording operation. The record RC-5 indicates the details when the processing device 200 transmits the condition information UI and the characteristic information TI to the cloud server CS but does not transmit the evaluation information HI, in one time recording operation. The record RC-6 indicates the details when the processing device 200 transmits the condition information UI to the cloud server CS, but does not transmit the characteristic information TI and the evaluation information HI, in one time recording operation.

The explanation returns to FIG. 10. After the process in step SS52 is completed, in step SS54, the cloud server CS functions as the determination unit 307 and adds the reward points corresponding to the provision of the evaluation information HI, which is part of the trigger information TRI, to the total of current reward points. For example, the reward points corresponding to the provision of the evaluation information HI is higher than the reward points corresponding to the provision of the condition information UI, and lower than the reward points corresponding to the provision of the characteristic information TI. For example, the reward points corresponding to the provision of the evaluation information HI are +3 points. The cloud server CS updates the reward point management table TDB with a total of added reward points.

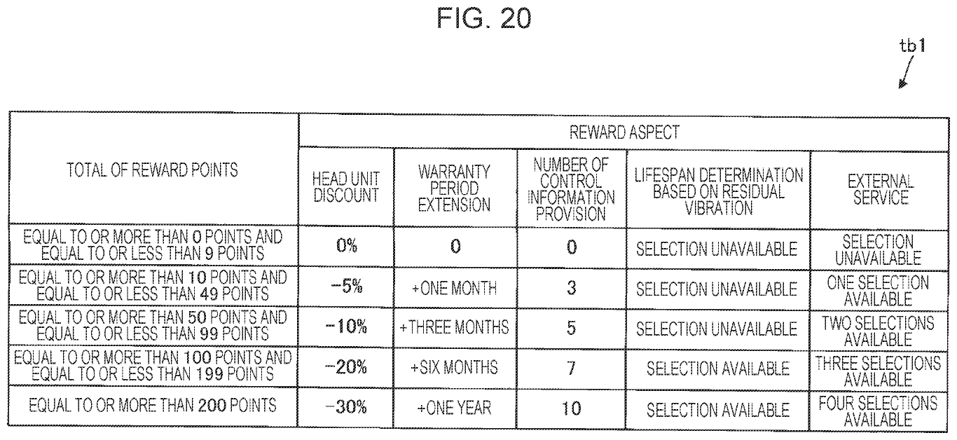

In FIG. 11, after the process in step SS54 is completed, or when the determination result in step SS50 is negative, in step SS56, the cloud server CS functions as the determination unit 307 and determines reward information PRI indicating one or a plurality of rewards based on the total of current reward points. Including the processes of step SS18, step SS44, and step SS56, it can be said that the determination unit 307 determines the reward information PRI based on the trigger information TRI. Further, the determination unit 307 sets the reward points corresponding to the provision of the characteristic information TI to be the highest, the reward points corresponding to provision of the evaluation information HI to the next highest, and the reward points corresponding to provision of the condition information UI to be the lowest. In other words, the determination unit 307 sets the act of providing the characteristic information TI as the weighting having the largest weight, sets the act of providing the evaluation information HI as the weighting having the next largest weight, and sets the act of providing the condition information UI as the weighting having the smallest largest weight. To simplify the explanation, the first embodiment will be described on the assumption that the number of the rewards that reward information PRI indicates is one. An example of determining the reward information PRI will be explained using FIG. 20.

FIG. 20 is a diagram for describing an example of determining the reward information PRI. For example, there are five types of rewards indicated by the reward information PRI. A table tb1 shown in FIG. 20 shows specific examples of five types of rewards.

The first type of reward is a purchase reward. The purchase reward is a reward granted when purchasing the head unit HU. For example, when the user U purchases the head unit HU different from the head unit HU in the ink jet printer 100, the purchase reward is a reward that makes it possible to purchase the head unit HU to be purchased at a discount, or a reward in which an additional product of the head manufacturer is provided free of charge in addition to the purchased head unit HU to be purchased. The head manufacturer's products include, for example, another head unit HU and an ink pack containing ink that can be used with the another head unit HU. FIG. 20 shows, as an example of the purchase reward, a reward that makes it possible to purchase the head unit HU at a discount.

The second type of reward is a warranty reward. The warranty reward is a reward related to a warranty of the head unit HU. For example, the warranty reward is a reward that makes it possible to extend the warranty period of the head unit HU to be purchased, or a reward that allows the user U to receive telephone support on the head unit HU, when the user U purchases the head unit HU different from the head unit HU in the ink jet printer 100. In FIG. 20, the reward that makes it possible to extend the warranty period of the head unit HU to be purchased is shown as the warranty reward.

The third type of reward is the number of control information provision reward. The number of control information provision reward is a reward related to the number of the control information CI transmitted from the cloud server CS based on the condition information UI. The number of control information provision reward is, for example, a reward that makes it possible to receive the provision of one or more pieces of control information CI.

The fourth type of reward is a lifespan determination reward. The lifespan determination reward is a reward related to a method of determining the lifespan of the head unit HU. The lifespan determination reward is, for example, a reward that makes it possible to execute a method of determining the lifespan of the head unit HU based on residual vibration, and a reward that makes it possible to execute a method of determining the lifespan of the head unit HU based on the number of ejections. The residual vibration is a vibration that remains in the pressure chamber CV after a drive element 111f, which is a piezoelectric element, is displaced by supplying the drive signal Com. Information indicating the residual vibration can be acquired by acquiring the potential according to the electromotive force of the drive element 111f caused by the residual vibration. Generally, the amplitude of the residual vibration decreases as the drive element 111f deteriorates. Therefore, the deterioration of the drive element 111f is reflected in the residual vibration. On the other hand, although there is a tendency for the drive element 111f to deteriorate as the number of ejections increases, it is unclear whether the drive element 111f actually deteriorates. Therefore, the method of determining the lifespan of the head unit HU based on residual vibration can determine the lifespan of the head unit HU more accurately than the method of determining the lifespan of the head unit HU based on the number of ejections. FIG. 20 shows, as an example of the lifespan determination reward, a reward that makes it possible to execute a method of determining the lifespan of the head unit HU based on residual vibration.

The fifth type of reward is an external service reward. The external service reward is a reward related to a service provided by a system different from the ink jet system 10. In the following description, a service provided by a system different from the ink jet system 10 may be referred to as an “external service”. Examples of the external service reward include a reward that makes it possible to use an external service that allows the user to reserve a beauty salon, and a reward that makes it possible to use an external service that allows the user to reserve acupressure, massage, or the like.

The purchase reward is an example of a “first reward”. The warranty reward is an example of a “second reward”. The number of control information provision reward is an example of a “third reward”. The lifespan determination reward is an example of a “fourth reward”. The external service reward is an example of a “fifth reward”.

As understood from FIG. 20, the determination unit 307 determines the reward information PRI so that the larger the reward points are, the greater the reward is. For example, it is assumed that the type of reward indicated by the reward information PRI is a reward that makes it possible to purchase the head unit HU at a discount. Based on this assumption, as understood from FIG. 20, the determination unit 307 determines the reward information PRI so that the larger the reward points are, the larger the discount rate is. For example, when reward points are equal to or more than 10 and equal to or less than 49, the determination unit 307 determines, as the reward information PRI, information indicating a reward that makes it possible to purchase the head unit HU at a 5% discount. Furthermore, when the reward points are equal to or more than 50 and equal to or less than 99, the determination unit 307 determines, as the reward information PRI, information indicating a reward that makes it possible to purchase the head unit HU at a 10% discount. When the type of reward indicated by the reward information PRI is a reward that makes it possible to purchase the head unit HU at a discount, an increase in the discount rate is an example of “the reward is greater”.

Further, it is assumed that the type of reward indicated by the reward information PRI is a reward that makes it possible to extend the warranty period of the head unit HU to be purchased. Based on this assumption, as understood from FIG. 20, the determination unit 307 determines the reward information PRI so that so that the larger the reward points are, the longer the warranty period is extended. When the type of reward indicated by the reward information PRI is a reward that makes it possible extend the warranty period of the head unit HU to be purchased, extending the warranty period longer is an example of “the reward is greater”.

Further, it is assumed that the type of reward indicated by the reward information PRI is the number of control information provision reward. Based on this assumption, as understood from FIG. 20, the determination unit 307 determines the reward information PRI so that the larger the reward points are, the larger the number of the control information CI provided is. When the type of reward indicated by the reward information PRI is the number of control information provision reward, an increase in the number of the control information CI provided is an example of “the reward is greater”.

Further, it is assumed that the type of reward indicated by the reward information PRI is a reward that makes it possible to execute a method of determining the lifespan of the head unit HU based on residual vibration. Based on this assumption, as can be understood from FIG. 20, when the reward points are equal to or more than 100, the determination unit 307 determines, as the reward information PRI, a reward that makes it possible to execute a method of determining the lifespan of the head unit HU based on residual vibration.

Further, it is assumed that the type of reward indicated by the reward information PRI is an external service reward. Based on this assumption, as understood from FIG. 20, the determination unit 307 determines the reward information PRI so that the larger the reward points are, the larger the number of external services that can be used is. When the type of reward indicated by the reward information PRI is an external service reward, an increase in the number of external services that can be used is an example of “the reward is greater”.

Further, as described above, the reward information PRI may indicate a plurality of rewards. For example, the description will be made assuming that the reward information PRI indicates two rewards. Based on this premise, when one reward type is a reward that makes it possible to purchase the head unit HU at a discount, and the other reward type is a reward that makes it possible to extend the warranty period of the head unit HU to be purchased, an increase in the discount the rate and extending the warranty period longer are an example of “the reward is greater”.

After determining the reward information PRI, the determination unit 307 updates the reward point management table TDB so as to subtract the consumption amount corresponding to the determined reward information PRI from the total of current reward points. For example, the cloud server CS stores consumption amount information having information corresponding to the table tb1 and consumption amount corresponding to each reward listed in the table tb1. For example, the consumption amount corresponding to a reward that makes it possible to purchase the head unit HU at a 30% discount is 200 points, and the consumption amount corresponding to a reward that makes it possible to execute a method of determining the lifespan of the head unit HU based on residual vibration is 100 points. The determination unit 307 refers to the consumption amount information and identifies the consumption amount corresponding to the determined reward information PRI.

After the process in step SS56 is completed, the cloud server CS functions as the reward grant unit 309, and in step SS58, grants the user U the reward indicated by the reward information PRI. For example, when the type of reward indicated by the reward information PRI is a reward that makes it possible to purchase the head unit HU at a discount, the cloud server CS generates coupon information indicating an image of a coupon that includes a barcode or a two-dimensional code that indicates that the head unit HU can be purchases at a discount to transmit the generated coupon information to the mobile terminal 700. In addition, when the type of reward indicated by the reward information PRI is an external service reward, the cloud server CS transmits a request for enabling the user U to use the external service via the network NW to a system that provides the external service.

After completing the process in step SS58, the cloud server CS transmits the reward information PRI to the processing device 200 in step SS60. Although not shown in FIG. 11, the cloud server CS may transmit the reward information PRI to the mobile terminal 700 instead of the processing device 200. In step SC62, the processing device 200 or the mobile terminal 700 displays, on its own display device, an image in which the user U can recognize the reward indicated by the reward information PRI. Note that the processing device 200 and the mobile terminal 700 are an example of a “first device”. However, when the ink jet printer 100 includes an input device and a display device, the ink jet printer 100 is also an example of a “first device”.

The transmission destination of the reward information PRI may change depending on the type of reward indicated by the reward information PRI. For example, when the type of reward indicated by the reward information PRI is a reward that makes it possible to purchase the head unit HU at a discount, and the cloud server CS transmits the coupon information to the mobile terminal 700, the cloud server CS transmits the reward information PRI to the mobile terminal 700. The mobile terminal 700 displays, on the display device 770, a character string indicating a reward that makes it possible to purchase the head unit HU at a discount, the character string being indicated by the reward information PRI, or an image indicated by the coupon information received from the cloud server CS. A character string indicating a reward that makes it possible to purchase the head unit HU at a discount is expressed as, for example, “Thank you for using our service. When you use the reward points you have earned to purchase the head unit next time, you can purchase the head unit at a discount”.

Further, when the type of reward indicated by the reward information PRI is the number of control information provision reward, the cloud server CS transmits, to the processing device 200, information indicating that the number of control information CI provided has increased. Based on the received information, for example, the processing device 200 displays, on the display device 770, a character string indicating that “The number of pieces of control information CI provided has increased”.

After completing the process in step SC62, the ink jet system 10 ends the series of processes shown in FIGS. 9, 10, and 11.

### 1-8. Summary of First Embodiment

As described above, the ink jet system 10 according to the first embodiment is an ink jet system that includes the ink jet printer 100 on which the head unit HU that ejects ink is mounted and that executes a recording operation on the recording medium PP, the processing device 200 that is coupled to the ink jet printer 100 and performs the data process for causing the ink jet printer 100 to execute the recording operation, and the cloud server CS that is configured to be coupled to either the ink jet printer 100 or the processing device 200. The cloud server CS authenticates the user U who causes the ink jet printer 100 to execute a recording operation, acquires the recording operation information PDI regarding the recording operation from the ink jet printer 100, the processing device 200, or the mobile terminal 700 used by the user U, determines the reward information PRI indicating one or a plurality of rewards based on the trigger information TRI including all of the recording operation information PDI, and grants the user U one or a plurality of rewards indicated by the reward information PRI. According to the ink jet system 10 according to the first embodiment, by granting a reward to the user U based on the trigger information TRI, the user U is motivated to provide the trigger information TRI, that is, the recording operation information PDI in the present embodiment, so that the cloud server CS can easily collect the recording operation information PDI. By making it easier to collect the recording operation information PDI, the head manufacturer can provide the user U with the more appropriate control information CI by updating the control program PM1 based on the recording operation information PDI.

Furthermore, the recording operation information PDI includes the condition information UI regarding conditions in the environment in which the head unit HU is used at the time of the recording operation, and the cloud server CS transmits the control information CI for controlling the recording operation based on the condition information UI to the ink jet printer 100 or the processing device 200. According to the ink jet system 10 according to the first embodiment, since the processing device 200 generates the control information CI according to the condition information UI, it is possible to generate the control information CI according to the conditions of use of the head unit HU.

Further, the head unit HU includes the drive element 111f that is a piezoelectric element, and the control information CI is information about the drive signal Com applied to the drive element 111f. According to the ink jet system 10 according to the first embodiment, the cloud server CS transmits information about the drive signal Com to the recording system 20, so that the recording system 20 can execute the recording operation according to the conditions of use of the head unit HU.

The recording operation information PDI includes the characteristic information TI regarding the ejection characteristic of the head unit HU when executing the recording operation based on the control information CI, and the evaluation information HI regarding the evaluation by the user U when executing the recording operation based on the control information CI. According to the ink jet system 10 according to the first embodiment, the head manufacturer can provide the appropriate control information CI from next time onward by referring to the characteristic information TI and the evaluation information HI. For example, when the information indicating the ejection amount included in the characteristic information TI indicates a smaller amount than expected by the head manufacturer, the head manufacturer modifies the control program PM1 so as to generate the control information CI that increases the ejection amount. Similarly, when the evaluation of the waveform providing period included in the evaluation information HI is the lowest evaluation, the head manufacturer speeds up the operation of the control program PM1, for example.

Further, the trigger information TRI includes at least one of the condition information UI, the characteristic information TI, and the evaluation information HI. According to the ink jet system 10 according to the first embodiment, since the reward information PRI is determined based on the information included in the trigger information TRI, the user U is motivated to provide at least one of the condition information UI, the characteristic information TI, and the evaluation information HI included in the trigger information TRI.

Further, the trigger information TRI includes at least the condition information UI and the characteristic information TI, and the cloud server CS determines the reward information PRI by weighting the characteristic information TI more than the condition information UI. As mentioned above, the head manufacturer can provide the appropriate control information CI from next time onward by referring the characteristic information TI, so that it can be said that the characteristic information TI is information the head manufacturer is more interested in collecting than the condition information UI. Therefore, according to the ink jet system 10 according to the first embodiment, by weighting the characteristic information TI more than the condition information UI to determine the reward information PRI, the user U is more likely to provide the characteristic information TI than the condition information UI, so that it is easier to provide the appropriate control information CI from next time onward.

Further, the trigger information TRI includes at least the condition information UI and the evaluation information HI, and the cloud server CS determines the reward information PRI by weighting the evaluation information HI more than the condition information UI. As mentioned above, the head manufacturer can provide the appropriate control information CI from next time onward by referring the evaluation information HI, so that it can be said that the evaluation information HI is information the head manufacturer is more interested in collecting than the condition information UI. Therefore, according to the ink jet system 10 according to the first embodiment, by determining the reward information PRI by weighting the evaluation information HI more than the condition information UI, the user U is more likely to provide the evaluation information HI than the condition information UI, so that it is easier to provide the appropriate control information CI from next time onward.

Further, the trigger information TRI includes at least the characteristic information TI and the evaluation information HI, and the cloud server CS determines the reward information PRI by weighting the characteristic information TI more than the evaluation information HI. Comparing the characteristic information TI with the evaluation information HI,

The characteristic information TI is uniquely determined when once the condition information UI is determined regardless of the user U, whereas since the evaluation information HI is determined by a sensory evaluation using the human five senses, the results will differ depending on the user U even when the condition information UI is determined. Specifically, regarding image quality, the state that the user U considers preferable differs depending on the user U. Therefore, the head manufacturer is more likely to be able to provide the appropriate control information CI to more users U by modifying the control program PM1 with more emphasis on the characteristic information TI than on the evaluation information HI. Therefore, according to the ink jet system 10 according to the first embodiment, by determining the reward information PRI by weighting the characteristic information TI more than the evaluation information HI, the user U is more likely to provide the characteristic information TI than the evaluation information HI, so that it is easier to provide the appropriate control information CI from next time onward.

The process of determining the reward information PRI includes calculating a score indicating the degree to which the user U has contributed to the ink jet system 10, that is, reward points, based on the trigger information TRI, and determining the reward information PRI so that the larger the reward points is, the greater the reward is. Since the larger the reward points are, the greater reward the user U is granted, it is possible to enhance the motivation for the user U to contribute to the ink jet system 10. Therefore, according to the ink jet system 10 according to the first embodiment, it is possible to enhance the motivation for the user U to contribute to the ink jet system 10, the user U is more likely to provide the trigger information TRI.

The processing device 200 includes the display device 270 that displays an image, and the processing device 200 receives the reward information PRI from the cloud server CS and displays, on the display device 270, an image in which the user U can recognize the reward indicated by the reward information PRI. Similarly, the mobile terminal 700 has the display device 770 that displays an image, and the mobile terminal 700 receives the reward information PRI from the cloud server CS and displays, on the display device 770, an image in which the user U can recognize the reward indicated by the reward information PRI. In an aspect in which an image in which the user U can recognize the reward indicated by the reward information PRI is not displayed, the user U cannot determine whether the reward has actually been granted. For example, user U may think that the reward was not granted because some conditions unknown to user U were not met. Therefore, until the user U can confirm that the reward has actually been granted, such as confirming that the head unit HU was purchased at a discount when the head unit HU was purchase, the user U may refrain from providing the trigger information TRI. On the other hand, the processing device 200 and the mobile terminal 700 display an image in which the user U can recognize the reward indicated by the reward information PRI, so that the user U can confirm that the reward has actually been granted. It can be said that the user U is more likely to continue the act of providing the trigger information TRI when the user U can confirm that the reward has been granted than when an image in which the user U can recognize the reward indicated by the reward information PRI is not displayed. Therefore, the user U is more likely to continue the act of providing the trigger information TRI in an aspect according to the ink jet system 10 according to the first embodiment than an aspect in which an image in which the user U can recognize the reward indicated by the reward information PRI is not displayed.

Moreover, the reward indicated by the reward information PRI may be a purchase reward. The user U can reduce the cost of using the ink jet system 10 in an aspect in which the reward indicated by the reward information PRI includes the purchase reward, compared with an aspect in which the rewards indicated by the reward information PRI do not include the purchase reward. Therefore, the user U is likely to continues to use the ink jet system 10 increases, and the period during which the user U continues to provide the trigger information TRI can be extended.

The reward indicated by the reward information PRI may be a warranty reward. The user U can tend to use the ink jet system 10 for a longer period of time in an aspect in which the reward indicated by the reward information PRI includes the warranty reward, than an aspect in which the rewards indicated by the reward information PRI do not include the warranty reward. When the user U uses the ink jet system 10 for a long period of time, the period during which the user U continues to provide the trigger information TRI can be extended.

The recording operation information PDI may include the condition information UI, the cloud server CS may transmit the one or more pieces of control information CI for controlling the recording operation to the ink jet printer 100 or the processing device 200 based on the condition information UI, and the reward indicated by the reward information PRI may be the number of control information provision reward. The user U is likely to obtain a preferable image in an aspect in which the reward indicated by the reward information PRI includes the number of control information provision reward, compared with an aspect in which the rewards indicated by the reward information PRI do not include the number of control information provision reward. Specifically, as described above, regarding image quality, the state that the user U considers preferable differs depending on the user U. Therefore, by providing more pieces of control information CI, an image that the user U finds preferable is more likely to be formed. The user U is likely to obtain a preferable image, so that it is generally possible to extend the period during which the user U continues to use the ink jet system 10.

Further, the reward indicated by the reward information PRI may be a lifespan determination reward. When the reward indicated by the reward information PRI includes the lifespan determination reward, the lifespan of the head unit HU can be determined. Therefore, the user U can prepare the next head unit HU in advance according to the lifespan of the head unit HU. Therefore, the period in which the head unit HU has failed and the recording operation cannot be executed can be shortened in an aspect according to the ink jet system 10 according to the first embodiment, compared to an aspect in which the next head unit HU is prepared after the head unit HU has failed.

Further, the reward indicated by the reward information PRI may be an external service reward. A mode in which reward points are consumed increases in an aspect in which the rewards indicated by reward information PRI includes the external service reward, compared with an aspect in which the reward indicated by reward information PRI does not include the external service reward, so that it is possible to improve convenience for the user U. In the present embodiment, description is made in which the determination unit 307 determines the reward information PRI so that the larger the reward points are, the larger the number of external services that can be used is, but the present disclosure is not limited to this. The external service reward may be, for example, a reward that makes it possible to exchange the reward points of the present embodiment for a service that provides points that can be used instead of cash.

### 2. Modifications

Each form illustrated above can be variously modified. Specific modifications are exemplified below. Two or more aspects optionally selected from the following exemplifications can be appropriately merged within a range not inconsistent with each other.

### 2-1. First Modification

As described above, the control information CI may be information about the image process. The information related to the image process, in the control information CI, is, for example, information indicating a portion or all of a lookup table used in a color conversion process included in the image process, information indicating a portion or all of a dither pattern used in a RIP process included in the image process, or information indicating a portion or all of the error diffusion matrix used in a RIP process included in the image process. Hereinafter, the first modification will be described assuming that the information about the image process is a lookup table.

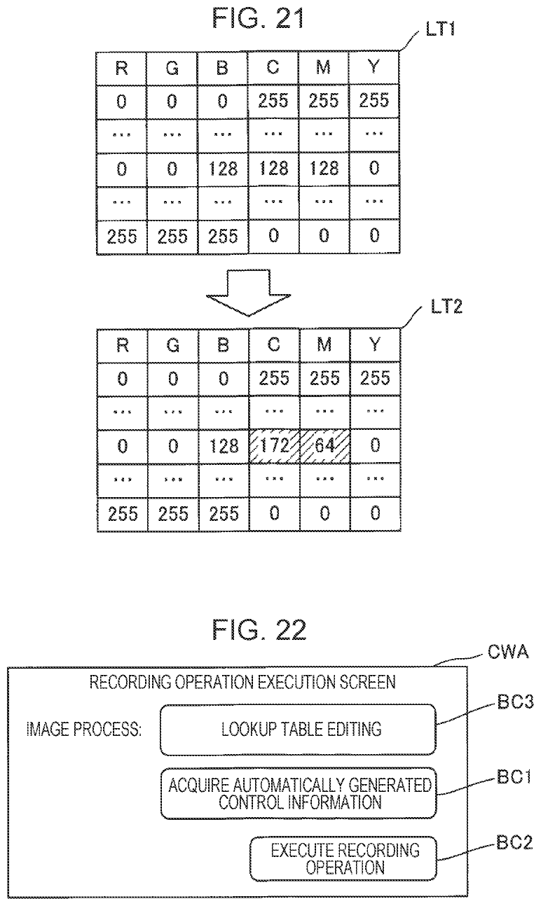

FIG. 21 is a diagram for describing an example of control information CI according to the first modification. FIG. 21 shows a lookup table LT1 that is the initial values of the ink jet program PM2 and a lookup table LT2 that is the control information CI according to the first modification. The difference between the lookup table LT1 and the lookup table LT2 is that the CMY values of (R, G, B)=(0, 0, 128) are converted from (C, M, Y)=(128, 128, 0) into (C, M, Y)=(172, 64, 0).

By changing the lookup table, the ink jet system 10 according to the first modification can perform an ejection operation according to the conditions of use of the head unit HU, as in the first embodiment. For example, when the ejection amount is reduced depending on the conditions of use of the head unit HU, one or more of the CMY values may be increased. For example, it is assumed that the information included in the condition information UI is information indicating the viscosity of ink, and that the viscosity is higher than general viscosity. Based on this premise, the generation unit 303 generates the lookup table so as to increase one or more of the CMY values. Even when the information included in the condition information UI is any one piece of or more pieces of the information about the type of the head unit HU, the information about the type of the recording medium PP, and the information about the temperature, the same applies as in the information about the type of ink.

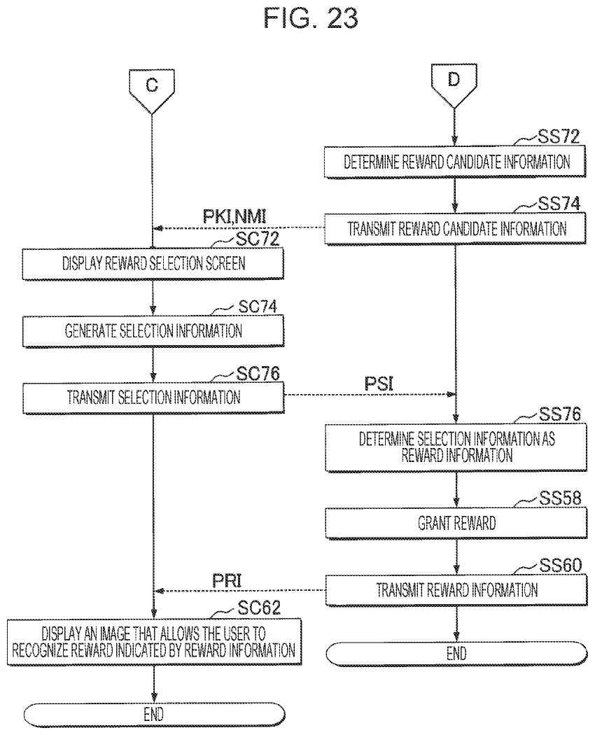

The series of operations of the ink jet system 10 according to the first modification differs from those of the first embodiment in that the recording operation execution screen CW displayed in step SC32 is different, and the process in step SC34 is different. A recording operation execution screen CWA according to the first modification will be explained using FIG. 22.

FIG. 22 is a diagram illustrating an example of the recording operation execution screen CWA according to the first modification. The recording operation execution screen CWA differs from the recording operation execution screen CW in that it has an edit button BC3 for editing the lookup table instead of the input field IC1.

When the edit button BC3 is pressed, the display device 270 displays an image showing each value of the lookup table under the control of the control circuit 210. The user U can edit each value of the displayed lookup table.

In the process of step SC34, the control circuit 210 receives the lookup table LT2, which is the control information CI according to the first modification, and overwrites the lookup table LT1 stored in the storage circuit 220 with the lookup table LT2. Alternatively, the control circuit 210 overwrites the lookup table LT1 stored in the storage circuit 220 with the lookup table edited by the user U when the edit button BC3 is pressed.

As described above, in the first modification, the processing device 200 generates the recording data DP used for the recording operation by executing an image process on the image data, and the control information CI in the first modification is information about the image process. According to the ink jet system 10 according to the first modification, the cloud server CS transmits information about the image process to the recording system 20, so that the recording system 20 can execute the ejection operation according to the conditions of use of the head unit HU The first modification does not require fine adjustment of the drive signal Com, compared with the first embodiment.

Therefore, in the Ink Jet System 10 According to the First modification, the drive element 111f may be a heat generating element. The heat generating element converts electrical energy into thermal energy, generates air bubbles inside the pressure chamber CV by heating, and changes the pressure inside the pressure chamber CV.

### 2-2. Second Modification

In each aspect described above, the reward indicated by the reward information PRI is one of five types of rewards, but the user U may be able to select from a plurality of types of rewards.

FIG. 23 is a flowchart showing a series of operations of the ink jet system 10 according to the second modification. The series of operations of the ink jet system 10 according to the second modification is different from the series of operations of the ink jet system 10 according to the first embodiment only in the part shown in FIG. 11. Therefore, only this different part will be explained, and the illustration of the operation of the part corresponding to FIGS. 9 and 10 will be omitted.

After the process in step SS54 is completed, or when the determination result in step SS50 is negative, the cloud server CS functions as the determination unit 307 and generates reward candidate information PKI based on the trigger information TRI in step SS72. The reward candidate information PKI indicates a plurality of rewards that is candidates for rewards to be granted to the user U. The plurality of reward candidates indicates, for example, two or more types of rewards among the five types of rewards described in the first embodiment.

More specifically, the determination unit 307 generates the reward candidate information PKI based on the total of current reward points. Here, the number of rewards indicated by the reward candidate information PKI may vary depending on the total of current reward points. Specifically, when the total of current reward points are equal to or more than 10 points and equal to or less than 49 points, the determination unit 307 generates the reward candidate information PKI indicating four rewards: the reward that makes it possible to purchase the head unit HU at a 5% discount, the reward that makes it possible to extend the warranty period of the head unit by one month, the reward that makes it possible to receive provision of three pieces of control information CI, and the reward that makes it possible to select one external service. Furthermore, when the total of current reward points are equal to or more than 50 points and equal to or less than 99 points, the determination unit 307 generates the reward candidate information PKI indicating four rewards: the reward that makes it possible to purchase the head unit HU at a 10% discount, the reward that makes it possible to extend the warranty period of the head unit by 3 months, the reward that makes it possible to receive provision of five pieces of control information CI, and the reward that makes it possible to the user to select two external services. In addition, when the total of current reward points are equal to or more than 100 points and equal to or less than 199 points, the determination unit 307 generates the reward candidate information PKI indicating five rewards: the reward that makes it possible to purchase the head unit HU at a 20% discount, the reward that makes it possible to extend the warranty period of the head unit by 6 months, the reward that makes it possible to receive provision of seven pieces of control information CI, the reward that makes it possible to execute a method of determining the lifespan of the head unit HU based on residual vibration, and the reward that makes it possible to select three external services. In addition, when the total of current reward points are equal to or more than 200 points, the determination unit 307 generates reward candidate information PKI indicating five rewards: the reward that makes it possible to purchase the head unit HU at a 30% discount, the reward that makes it possible to extend the warranty period of the head unit by one year, the reward that makes it possible to receive provision of 10 pieces of control information CI, the reward that makes it possible to execute a method of determining the lifespan of the head unit HU based on residual vibration, and the reward that makes it possible to select four external services. As can be understood from the above, in the above example, when the total of current reward points are less than 100 points, the reward candidate information PKI indicates four rewards, and when the total of current reward points are equal to or more than 100 points the reward candidate information PKI indicates five rewards.

After completing the process in step SS72, the cloud server CS transmits the reward candidate information PKI and a next reward point NMI indicating the reward points until the next maximum number of rewards is reached to the processing device 200 or the mobile terminal 700 in step SS74. The next reward point NMI is a value obtained by subtracting the total of current reward points from the total reward points corresponding to the next maximum number of rewards. Note that the cloud server CS does not need to transmit the next reward point NMI in step SS74. After completing the process in step SS74, the cloud server CS waits for a response from the processing device 200 or the mobile terminal 700.

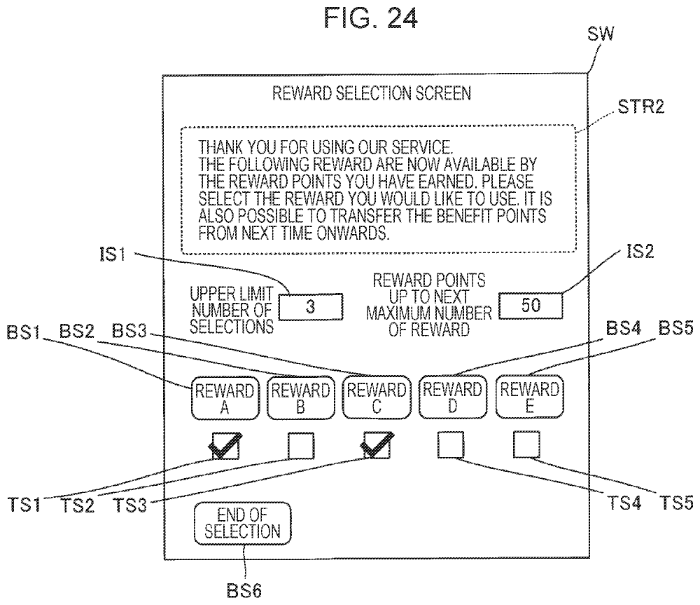

When the processing device 200 or the mobile terminal 700 receives the reward candidate information PKI, the processing device 200 or the mobile terminal 700 displays a reward selection screen SW on its own display device in step SC72. The reward selection screen SW will be explained using FIG. 24.

FIG. 24 is a diagram showing an example of the reward selection screen SW. In FIG. 24, to simplify the explanation, an example will be described in which the processing device 200 displays the reward selection screen SW. The reward selection screen SW shown in FIG. 24 shows an example in which the reward candidate information PKI indicates five rewards: a reward A, a reward B, a reward C, a reward D, and a reward E. The reward selection screen SW includes a character string STR2 that prompts the user U to select a reward, a selection upper limit number region IS1 where the upper limit number of selections indicating the number of rewards that the user U can select is indicated, a next reward point region IS2 where the reward points indicating the next reward point NMI are displayed, validation buttons BS1 to BS5 for checking the details of rewards A to E, respectively, and checkboxes TS1 to TS5 for selecting rewards A to E, respectively, and a selection end button BS6 for ending selection of rewards.

FIG. 24 shows an example in which the current reward points are 150 points. Therefore, for example, the reward A is a reward that makes it possible to purchase the head unit HU at a 20% discount. The reward B is a reward that makes it possible to extend the warranty period of the head unit by 6 months. The reward C is a reward that makes it possible to receive provision of seven pieces of control information CI. The reward D is a reward that makes it possible to execute a method of determining the lifespan of the head unit HU based on residual vibration. The reward E is a reward that makes it possible to select three external services. Further, an example is shown in which the reward points displayed in the next reward point region IS2 shown in FIG. 24 is 200 points−150 points=50 points. Further, in the selection upper limit number region IS1, a predetermined number set by the head manufacturer is set. In the example of FIG. 24, the upper limit number of selections is three.

When any one of the validation buttons BS1 to BS5 is pressed, the display device 270 displays a character string indicating the reward corresponding to the pressed button under the instruction from the control circuit 210. For example, when the validation button BS1 is pressed, a character string indicating that the head unit HU can be purchased at a discount is displayed.

When any one of the checkboxes TS1 to TS5 is pressed, the display device 270 displays an image in which the pressed checkbox is selected under the instruction from the control circuit 210. In the example of FIG. 24, a checkbox TS1 and a checkbox TS3 are selected.

When the selection end button BS6 is pressed, the control circuit 210 determines whether the number of checkboxes selected by the user U among the checkboxes TS1 to TS5 is less than or equal to the upper limit number of selections displayed in the selection upper limit number region IS1. When the number of selected checkboxes is greater than the upper limit number of selections, the control circuit 210 displays a warning dialog notifying the user U that the number of selected checkboxes should be less than or equal to the upper limit number of selections displayed in the selection upper limit number region IS1, and the selection end button BS6 should be pressed again.

The explanation returns to FIG. 24. When the number of selected checkboxes is less than or equal to the selection upper limit number, the control circuit 210 generates selection information PSI indicating the reward corresponding to the selected checkbox in step SC74. The selection information PSI can be said to indicate one or a plurality of rewards selected by the user U using the input device 260. After completing the process in step SC74, the processing device 200 transmits the selection information PSI to the cloud server CS in step SC76.

When receiving the selection information PSI, the cloud server CS determines the selection information PSI as the reward information PRI in step SS76. After completing the process in step SS76, the cloud server CS executes the process in step SS58.

As described above, in the ink jet system 10 according to the second modification, the processing device 200 includes the input device 260 that receives operation information indicating the operation of the user U, and a process of determining the reward information PRI includes generating the reward candidate information PKI indicating a plurality of rewards that is candidates for rewards to be granted to the user U based on the trigger information TRI, transmitting the reward candidate information PKI to the processing device 200, receiving, from the processing device 200, the selection information PSI indicating one or a plurality of rewards selected by the user U using the input device 260 among a plurality of rewards indicated by the reward candidate information PKI, and determining the selection information PSI as the reward information PRI. The mobile terminal 700 includes the input device 760 that receives operation information indicating an operation by the user U, and a process of determining the reward information PRI includes generating the reward candidate information PKI based on the trigger information TRI, transmitting the reward candidate information PKI to the processing device 200, receiving the selection information PSI from the mobile terminal 700, and determining the selection information PSI as the reward information PRI. IN the ink jet system 10 according to the second modification, the user U can select a reward from among a plurality of rewards indicated by the reward candidate information PKI, so that it is possible to improve convenience for the user U.

Note that, as shown in FIG. 23, also in the second modification, in step SC62, the processing device 200 and the mobile terminal 700 display, on their own display device, an image in which the user U can recognize the reward indicated by the reward information PRI, but the present disclosure is not limited to this. The processing device 200 and the mobile terminal 700 may not display an image in which the user U can recognize the reward indicated by the reward information PRI on their own display devices.

### 2-3. Third Modification

In each of the above aspects, the trigger information TRI may include purchase history information about the purchase history of the head unit HU by the user U. For example, the purchase history information includes one piece of or a plurality of pieces of information indicating the number of head units HU purchased by user U, information indicating the type of head units HU purchased by user U, and information indicating the date and time when the user U purchased the head units HU. For example, the determination unit 307 adds reward points according to the purchase history information to the total of current reward points. For example, when the purchase history information is the number of head units HU purchased by user U, the determination unit 307 increases the reward points according to the purchase history information as the number of head units HU purchased by the user U increases.

When the trigger information TRI includes the purchase history information, for example, the more head units HU the user U purchases, the greater the reward granted to the user U, so that it is possible to enhance the possibility that the user U continue to use the ink jet system 10.

### 2-4. Fourth Modification

In each of the above aspects, the trigger information TRI may include introduction history information about the introduction history of another user by the user U. For example, the introduction history information includes one piece of or a plurality of pieces of information indicating the number of other users whom the user U introduces to the ink jet system 10, and information indicating the date and time when the user U introduced another user to the ink jet system 10. For example, the determination unit 307 adds reward points according to the introduction history information to the total of current reward points. For example, when the introduction history information is the number of other users whom the user U has introduced to the ink jet system 10, the determination unit 307 increases the reward points according to the introduction history information as the number of other users whom the user U has introduced to the ink jet system 10 increases.

It can be said that the greater the number of other users that the user U has introduced to the ink jet system 10, the greater the degree to which the user U has contributed to the ink jet system 10. Therefore, according to the ink jet system 10 according to the fourth modification, since the trigger information TRI includes the introduction history information, a large reward can be granted to the user U who has made a large contribution.

### 2-5. Fifth Modification

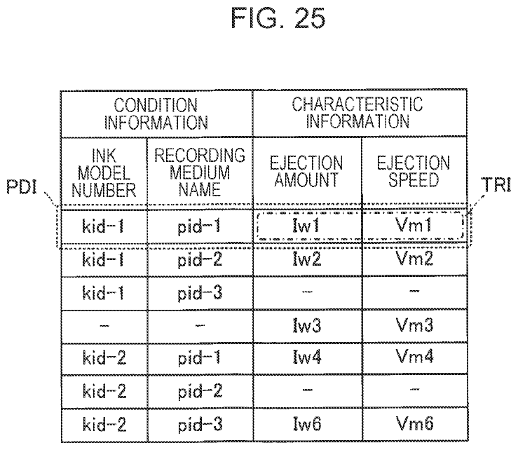

In each of the above aspects, the recording operation information PDI includes the condition information UI, the characteristic information TI, and the evaluation information HI, but the recording operation information PDI is only required to include at least one of the condition information UI, the characteristic information TI, and the evaluation information HI. The fifth modification is shown using FIG. 25.

FIG. 25 is a diagram for describing the recording operation information PDI and the trigger information TRI in the fifth modification. The recording operation information PDI in the fifth modification includes the condition information UI and the characteristic information TI. The trigger information TRI in the fifth modification is the characteristic information TI. In this way, the recording operation information PDI is only required to include at least one of the condition information UI, the characteristic information TI, and the evaluation information HI, and the trigger information TRI may include only part of the recording operation information PDI.

### 2-6. Sixth Modification

In each of the above aspects, when the condition information UI acquired from the recording system 20 is not the condition information UI that the head manufacturer has, the reward information PRI may be determined so that the reward granted to the user U is great.

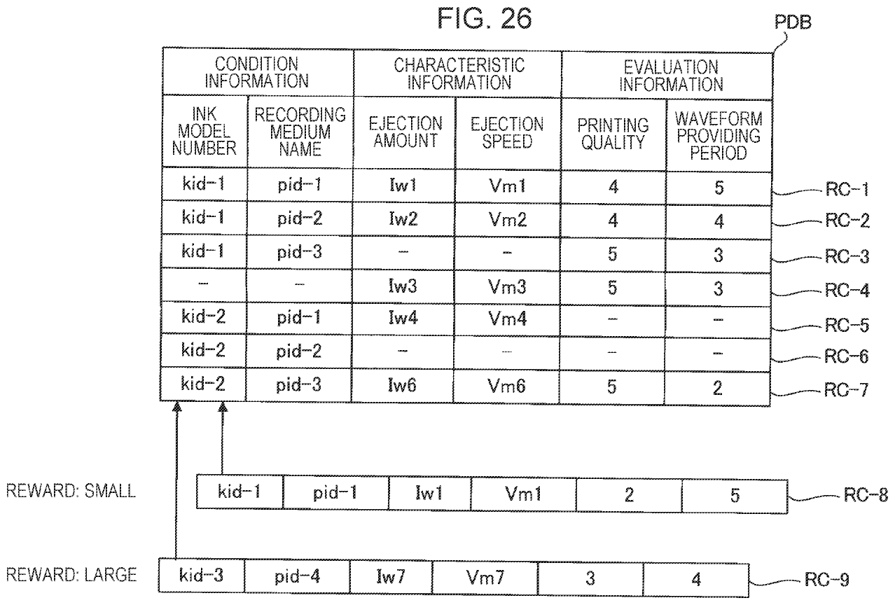

FIG. 26 is a diagram for describing the determination unit 307 according to the sixth modification. The cloud server CS can access the recording operation information database PDB. As described above, the recording operation information database PDB has a history of the condition information UI. The recording operation information database PDB is stored in the storage circuit 320. Note that the recording operation information database PDB is an example of “condition information history information”. The storage circuit 320 is an example of a “storage device that stores condition information history information”.

The recording operation information database PDB may be stored in a storage device other than the storage circuit 320 in the server 300, such as a database server. In this case, the cloud server CS can access the storage device in which the recording operation information database PDB is stored via the network NW.

After the determination result in step SS10 is affirmative, the determination unit 307 determines, before process in step SS16, whether information same as the condition information UI received from the recording system 20 is included in the recording operation information database PDB. Then, the determination unit 307 determines the reward information PRI based on whether information same as the received condition information UI is included in the recording operation information database PDB and the trigger information TRI. The size of the reward when information same as the received condition information UI is not included in the recording operation information database PDB is greater than the size of the reward when information same as the received condition information UI is included in the recording operation information database PDB.

For example, it is assumed that the cloud server CS receives the condition information UI of a record RC-8 shown in FIG. 26 in a certain recording operation. As understood from FIG. 26, information same as the condition information UI of the record RC-8 is included as the condition information UI of a record RC-1 in the recording operation information database PDB. Further, it is assumed that the cloud server CS receives the condition information UI of a record RC-9 shown in FIG. 26 in a recording operation different from the recording operation described above. As understood from FIG. 26, information same as the condition information UI of the record RC-9 does not exist in the recording operation information database PDB. Therefore, the determination unit 307 sets a size of the reward indicated by the reward information PRI determined based on the trigger information TRI of the record RC-9 to be larger than a size of the reward indicated by the reward information PRI determined based on the trigger information TRI of the record RC-8. For example, in step SS18, step SS44, and step SS54, the determination unit 307 sets reward points corresponding to the provision of the trigger information TRI of the record RC-9 to be larger than reward points corresponding to the provision of the trigger information TRI of the record RC-8 by a constant multiple greater than one. The constant is, for example, a positive integer such as 2 or 3.

As described above, in the ink jet system 10 according to the sixth modification, the recording operation information PDI includes at least the condition information UI, the cloud server CS can access the storage circuit 320 having the recording operation information database PDB having the history of the condition information UI, and the determination unit 307, which is a process of determining the reward information PRI, determines the reward information PRI so that the size of the reward when information same as condition information UI included in the recording operation information PDI is not included in the recording operation information database PDB is larger than the size of the reward when information same as condition information UI included in the recording operation information PDI is included in the recording operation information database PDB. According to the ink jet system 10 according to the sixth modification, when the condition information UI acquired from the recording system 20 is not the condition information UI that the head manufacturer has, the reward granted to the user U is great, so that it is possible to enhance the motivation for the user U to provide the recording operation information PDI. Therefore, it is possible to cover more recording operation information PDI related to the use condition that is not expected by the head manufacturer according to the ink jet system 10 according to the sixth modification, compared with the ink jet system 10 according to the first embodiment.

In order to make the above-mentioned effect more noticeable, the cloud server CS may notify the user U that the reward to be granted to the user U will be great when the condition information UI acquired from the recording system 20 is not the condition information UI that the head manufacturer has, compared with when the condition information UI acquired from the recording system 20 is the condition information UI that the head manufacturer has. Specifically, after the determination result in step SS10 is affirmative, it is assumed that the cloud server CS determines, before the process in step SS16, that information same as the condition information UI received from the recording system 20 is not included in the recording operation information database PDB. Under this assumption, the cloud server CS transmits, to the processing device 200, information indicating that the reward points resulting from the provision of the recording operation information PDI will be larger than the normal reward points. The normal reward point is a reward point obtained by providing the recording operation information PDI when information same as the condition information UI received from the recording system 20 is included in the recording operation information database PDB. Under the instruction of the control circuit 210, the display device 270 displays, on one or both of the characteristic information acquisition screen TW and the evaluation information acquisition screen HW, a character string indicating that the reward points due to the provision of the recording operation information PDI will be larger than the normal reward points. For example, when this character string is displayed on the characteristic information acquisition screen TW, it says, “In the recording operation at this time, when you send characteristic information, you can earn reward points greater than the normal reward points.

### 2-7. Seventh Modification

In each of the above aspects, when the ink jet printer 100 includes an input device and a display device, and functions as the authentication information acquisition unit 211, the condition information acquisition unit 213, the controller 215, the characteristic information acquisition unit 217, and the evaluation information acquisition unit 219, the control circuit 170 functions as the authentication information acquisition unit 211, the condition information acquisition unit 213, the controller 215, the characteristic information acquisition unit 217, and the evaluation information acquisition unit 219, but the present disclosure is not limited this. For example, when the head unit HU includes a control circuit such as a CPU, this control circuit may function as the authentication information acquisition unit 211, the condition information acquisition unit 213, the controller 215, the characteristic information acquisition unit 217, and the evaluation information acquisition unit 219.

### 2-8. Eighth Modification

In each of the above aspects, when the ink jet printer 100 is configured to be coupled to the network NW, the communication device 150 is coupled to the network NW, but the present disclosure is not limited to this. For example, when the head unit HU includes a communication device, this communication device may communicate with the network NW.

### 2-9. Ninth Modification

In each of the aspects described above, the serial ink jet printer 100 in which the head unit HU is reciprocated in the direction along the X axis is exemplified, but the present disclosure is not limited to such aspects. The ink jet printer 100 may be a line-type liquid ejection apparatus in which a plurality of nozzles Nz is distributed over the entire width of the recording medium PP.

### 2-10. Other Modifications

The ink jet printer 100 described above can be employed in various devices such as a facsimile machine and a copier, in addition to a device dedicated to printing. Further, the application of the recording device of the present disclosure is not limited to printing. For example, a recording device that ejects a solution of a color material is used as a manufacturing device that forms a color filter for a liquid crystal display device. Further, a recording device that ejects a solution of a conductive material is used as a manufacturing device that forms wiring on a wiring substrate and electrodes.

What is claimed is:

1. An ink jet system comprising:
a recording device on which a head unit that ejects ink is mounted and that executes a recording operation on a recording medium;
a processing device coupled to the recording device and performing a data process for causing the recording device to execute the recording operation; and
a server configured to be coupled to either the recording device or the processing device, wherein
the server
authenticates a user who causes the recording device to execute the recording operation,
acquires recording operation information about the recording operation from the recording device, the processing device, or a terminal device used by the user,
determines reward information indicating one or a plurality of rewards based on trigger information including part of or all of the recording operation information, and
grants the user one or a plurality of rewards indicated by the reward information.

2. The ink jet system according to claim 1, wherein
the recording operation information includes condition information about a condition in an environment in which the head unit is used during the recording operation, and wherein
the server
transmits, to the recording device or the processing device, control information for controlling the recording operation based on the condition information.

3. The ink jet system according to claim 2, wherein
the head unit includes a drive element, and wherein
the control information includes information about a drive signal applied to the drive element.

4. The ink jet system according to claim 2, wherein
the processing device generates recording data used in the recording operation by executing an image process on image data, and wherein
the control information includes information about the image process.

5. The ink jet system according to claim 2, wherein
the recording operation information includes
characteristic information about an ejection characteristic of the head unit when the recording operation is executed based on the control information, and
evaluation information about evaluation by the user when the recording operation is executed based on the control information.

6. The ink jet system according to claim 5, wherein
the trigger information includes at least one of the condition information, the characteristic information, and the evaluation information.

7. The ink jet system according to claim 6, wherein
the trigger information includes at least the condition information and the characteristic information, and wherein
the server determines the reward information by weighting the characteristic information more than the condition information.

8. The ink jet system according to claim 6, wherein
the trigger information includes at least the condition information and the evaluation information, and wherein
the server determines the reward information by weighting the evaluation information more than the condition information.

9. The ink jet system according to claim 6, wherein
the trigger information includes at least the characteristic information and the evaluation information, and wherein
the server determines the reward information by weighting the characteristic information more than the evaluation information.

10. The ink jet system according to claim 1, wherein
the trigger information includes purchase history information about a purchase history of the head unit by the user.

11. The ink jet system according to claim 1, wherein
the trigger information includes introduction history information about an introduction history of another user by the user.

12. The ink jet system according to claim 1, wherein
a process of determining the reward information includes
calculating a score indicating a degree to which the user contributed to the ink jet system based on the trigger information, and
determining the reward information so that the larger the score is, the greater a reward is.

13. The ink jet system according to claim 1, wherein
a first device that is any one of the recording device, the processing device, and the terminal device includes a display device that displays an image, and wherein
the first device
receives the reward information from the server, and
displays, on the display device, an image in which the user is allowed to recognize one or a plurality of rewards indicated by the reward information.

14. The ink jet system according to claim 1, wherein
a first device that is any one of the recording device, the processing device, and the terminal device includes an input device that receives operation information indicating an operation by the user, and wherein
a process of determining the reward information includes
generating reward candidate information indicating a plurality of rewards that is candidates for a reward to be granted to the user based on the trigger information,
transmitting the reward candidate information to the first device,
receiving, from the first device, selection information indicating one or a plurality of rewards selected by the user using the input device from among a plurality of rewards indicated by the reward candidate information, and
determining the selection information as the reward information.

15. The ink jet system according to claim 1, wherein
one or a plurality of rewards indicated by the reward information include a first reward related to when purchasing a head unit different from the head unit.

16. The ink jet system according to claim 1, wherein
one or a plurality of rewards indicated by the reward information include a second reward related to a warranty for a head unit different from the head unit.

17. The ink jet system according to claim 1, wherein
the recording operation information includes condition information about a condition in an environment in which the head unit is used during the recording operation, wherein
the server transmits, to the recording device or the processing device, one or more pieces of control information for controlling the recording operation based on the condition information, and wherein
one or a plurality of rewards indicated by the reward information include a third reward related to the number of the one or more pieces of control information transmitted from the server based on the condition information.

18. The ink jet system according to claim 1, wherein
one or a plurality of rewards indicated by the reward information include a fourth reward related to a method of determining a lifespan of the head unit.

19. The ink jet system according to claim 1, wherein
one or a plurality of rewards indicated by the reward information include a fifth reward related to a service provided by a system different from the ink jet system.

20. The ink jet system according to claim 2, wherein
the recording operation information includes at least the condition information, wherein
the server is configured to access a storage device that stores condition information history information having a history of condition information about a condition in an environment in which the head unit is used during the recording operation, and wherein
a process of determining the reward information includes
determining the reward information so that a size of a reward when information same as the condition information included in the recording operation information is not included in the condition information history information is greater than a size of a reward when information same as the condition information included in the recording operation information is included in the condition information history information.
